(19) United States
(12) Patent Application Publication
(10) Pub. No.: US 2024/0004279 A1
(43) Pub. Date: Jan. 4, 2024

(54) LIGHT SOURCE MODULE, LIGHT SOURCE DEVICE, AND PROJECTION APPARATUS

(71) Applicant: Ricoh Company, Ltd., Tokyo (JP)

(72) Inventors: Tomoya FUJII, Kanagawa (JP); Yuuto AKIBA, Kanagawa (JP); Kazuhiro FUJITA, Tokyo (JP); Takashi SASAKI, Kanagawa (JP)

(21) Appl. No.: 18/332,409

(22) Filed: Jun. 9, 2023

(30) Foreign Application Priority Data
Jun. 29, 2022 (JP) 2022-104987
Mar. 3, 2023 (JP) 2023-033205

(51) Int. Cl. G03B 21/20; H04N 9/31

(52) U.S. Cl. CPC G03B 21/204; G03B 21/208; G03B 21/2013; G03B 21/2066; H04N 9/3164; H04N 9/3161

(57) ABSTRACT

A light source module includes: a light source to emit a light beam having a first wavelength band in a first direction; a first condenser lens to condense the light beam emitted from the light source in the first direction; a condenser optical system to condense the light beam from the first condenser lens in a second direction orthogonal to the first direction to form an irradiation spot; a wavelength converter to convert the first wavelength band of the light beam condensed by the condenser optical system into a light beam having a second wavelength band; a second condenser lens to condense the light beam having the second wavelength band at a predetermined position, a first adjuster to adjust a position of the first condenser lens; and a second adjuster to adjust a position of the second condenser lens.

This patent application is based on and claims priority pursuant to 35 U.S.C. § 119(a) to Japanese Patent Application No. 2022-104987, filed on Jun. 29, 2022, in the Japan Patent Office, and Japanese Patent Application No. 2023-033205, filed on Mar. 3, 2023, in the Japan Patent Office, the entire disclosure of which are hereby incorporated by reference herein.

### BACKGROUND

### Technical Field

The present disclosure relates to a light source module, a light source device, and a projection apparatus.

### Related Art

A light source device using laser light and a phosphor for illumination light in a projection apparatus is known. In the light source device, the laser light beam emitted from the light source excites the phosphor to generate fluorescent light having a wavelength band different from a wavelength band of the excitation light. The fluorescent light is used for illumination light.

In order to obtain brighter light in the projection apparatus, for example, an adjuster to adjust the optical axis of an optical system to combine multiple light paths is used.

### SUMMARY

A light source module includes: a light source to emit a light beam having a first wavelength band in a first direction; a first condenser lens to condense the light beam emitted from the light source in the first direction; a condenser optical system to condense the light beam from the first condenser lens in a second direction orthogonal to the first direction to form an irradiation spot; a wavelength converter to convert the first wavelength band of the light beam condensed by the condenser optical system into a light beam having a second wavelength band; a second condenser lens to condense the light beam having the second wavelength band converted by the wavelength converter at a predetermined position, a first adjuster to adjust a position of the first condenser lens in at least one of the second direction or a third direction orthogonal to each of the first direction and the second direction; and a second adjuster to adjust a position of the second condenser lens in at least one of the first direction or the third direction.

Further, an embodiment of the present disclosure provides a light source device including; the light source module described above; and a light homogenizer having a light incident opening in one end of the light homogenizer in a longitudinal direction of the light homogenizer, the light incident opening having a rectangle shape having a longitudinal side and a lateral side. The light source module described above includes: a first light source module to emit a first light beam to the light homogenizer in a fourth direction to form a first light condensed spot at a first position in the light incident opening; a second light source module to emit a second light beam to the light homogenizer in a fifth direction to form a second light condensed spot at a second position adjacent to the first light condensed spot in the light incident opening; and a reflector to bent one of the first light beam and the second light beam to align an emission direction of the first light beam and the second light beam to one of the fourth direction or the fifth direction. The fourth direction is one of the first direction and the second direction, and the fifth direction is another of the first direction and the second direction.

Further, an embodiment of the present disclosure provides a projection apparatus including: a light source device described above; an image generation element to generate an image; an illumination optical system to guide a light beam emitted from the light source device to the image generation element; and a projection lens to project the image.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram of a configuration of a display apparatus according to a present embodiment;

FIG. 2 is a diagram of a configuration of a light source device according to a present embodiment;

FIG. 3 is a diagram of a phosphor wheel;

FIG. 4 is a diagram of a color wheel;

FIG. 5 is a perspective view of condenser lenses and adjusters installed in the light source device;

FIG. 6A is a perspective view of a configuration of lens holders and the adjusters;

FIG. 6B is a front view of the configuration of the lens holders and the adjusters as viewed from the −x-direction in FIG. 6A;

FIG. 6C is another front view of the configuration of the lens holders and the adjusters as viewed from the −z-direction in FIG. 6A;

FIG. 7 is a perspective view of the configuration of the lens holder and the adjuster;

FIG. 8A is a perspective view of the configuration of the lens holder;

FIG. 8B is a top view of the configuration of the lens holder as viewed from the +y-direction in FIG. 8A;

FIG. 9A is a perspective view of the configuration of the lens holder;

FIG. 9B is a top view the configuration of the lens holder as viewed from the +y-direction in FIG. 9A;

FIG. 10 is a perspective view of the appearance of the lens holder;

FIG. 11 is another perspective view of the appearance of the lens holder;

FIG. 12 is an exploded view of the lens holder;

FIG. 13 is another exploded view of the lens holder;

FIG. 14 is a front view of a first adjustment member and a second adjustment member of the lens holder as viewed from the −z-direction;

FIG. 15 is a side view of the first adjustment member and the second adjustment member of the lens holder in FIG. 14 as viewed from the −x-direction;

FIG. 16 is a top view of the first adjustment member and the second adjustment member of the lens holder in FIGS. 14 and 15 as viewed from the +y-direction;

FIG. 17 is a perspective view of the appearance of a first holder;

FIG. 18 is another perspective view of the appearance of the first holder;

FIG. 19 is a perspective view of the appearance of a second holder;

FIG. 20 is another perspective view of the appearance of the second holder;

FIG. 21 is a perspective view of the appearance of a holder base;

FIG. 22 is another perspective view of the appearance of the holder base;

FIG. 23 is a diagram of the light source device including a casing member;

FIG. 24 is a diagram of an arrangement of the optical components in the light source device in FIG. 23;

FIG. 25A is a diagram of an optical path of an excitation light beam emitted from a light source to the phosphor wheel;

FIG. 25B is another diagram of the optical path of the excitation light beam emitted from the light source to the phosphor wheel;

FIG. 26A is a diagram of an optical path of a fluorescent light beam emitted from the phosphor wheel to the light tunnel;

FIG. 26B is another diagram of the optical path of the fluorescent light beam emitted from the phosphor wheel to the light tunnel;

FIG. 27 is a diagram of irradiations spots of fluorescence at a light incident opening of the light tunnel; and

FIG. 28 is a block diagram of a hardware configuration of the display apparatus.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present invention, the light use efficiency of the light source module can be increased.

Herein, embodiments of a light source module, a light source device and a projection apparatus (display apparatus) will be described in detail with reference to the accompanying drawings.

Example of Configuration of Display Apparatus

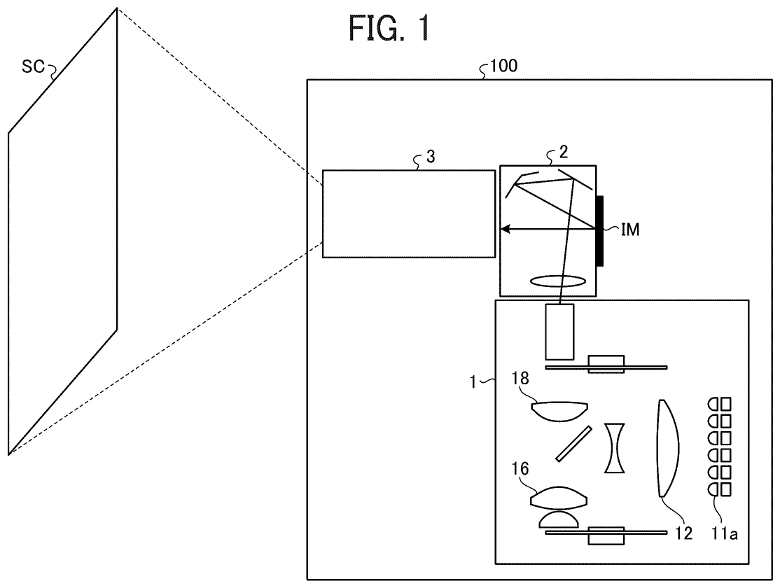

FIG. 1 is a diagram of a configuration of a display apparatus 100 such as a projection apparatus (projector) according to the present embodiment. The display apparatus 100 projects a predetermined image onto, for example, a screen.

As illustrated in FIG. 1, the display apparatus 100 includes a light source device 1, an illumination optical system 2, and a projection optical system 3.

The light source device 1 includes, for example, a light source 11a (first light source), a condenser lens 12, a condenser lens 16, a condenser lens 18 (second condenser lens), and converts a wavelength band of the laser light beam emitted from the light source 11a into another wavelength band, and emits a uniform light beam to the illumination optical system 2. The configuration of the light source device 1 will be described later in detail.

The illumination optical system 2 includes, for example, an image generation element IM and forms an image to be projected outside the display apparatus 100. Examples of the image generation element IM include a digital light processing (DLP (trademark)) chip, a digital micromirror device (DMD), a transmissive liquid crystal panel, or a reflective liquid crystal panel. Such image generation elements receive a graphic signal from the outside of the display apparatus 100 and forms a projection image, and are disposed at a conjugation point of light incident from the light source device 1.

The light source device 1 substantially uniformly irradiates the image generation element IM with the light beam. The image generation element irradiated with the light beam generates a projection image based on a graphic signal received by the image generation element IM.

The projection optical system 3 projects the projection image formed by the illumination optical system 2 toward the outside of the display apparatus 100. Thus, the image formed by the illumination optical system 2 is enlarged and projected onto, for example, a screen SC installed outside the display apparatus 100.

In some embodiments, a projection apparatus includes: a light source device; an image generation element to generate an image; an illumination optical system to guide a light beam emitted from the light source device to the image generation element; and a projection lens configured to project the image.

Example of Configuration of Light Source Device

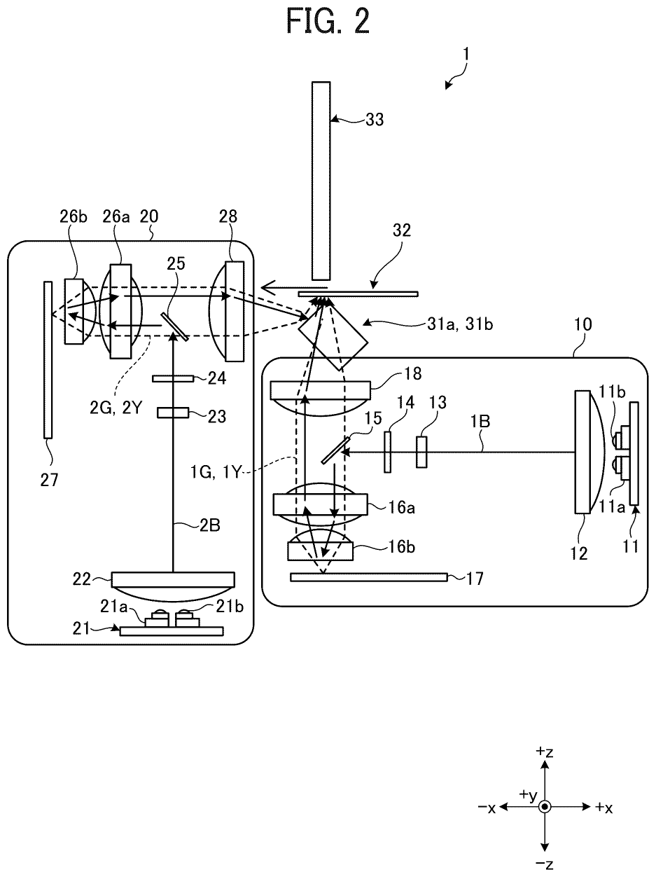

The light source device 1 according to the present embodiment will be described in detail with reference to FIG. 2. FIG. 2 is a diagram of the light source device 1 according to the present embodiment.

In the drawings, a coordinate system is depicted. The coordinate system is a three-dimensional Cartesian coordinate system. Herein, the z-direction (z-axis) is a front-back direction of the light source device 1. The z-direction is also the direction of the optical axis of the light source device 1. The z-direction has a +z-direction and a −z-direction, and the +z-direction and the −z-direction are opposite to each other. The +z-direction and the −z-direction match the front direction and the back direction of the light source device 1, respectively.

The x-direction (x-axis) is perpendicular to the z-direction and along an optical axis of the light source 11a described later. The x-direction matches the left-right direction of the light source device 1. The x-direction has a +x-direction (right direction) and a −x-direction (left direction), and the +x-direction and the −x-direction are opposite to each other. Herein, the +x-direction is a side on which a light tunnel 33 described later is disposed, and the −x-direction is an opposite side of the +x-direction.

The y-direction (y-axis) is perpendicular to the x-direction and the z-direction. The y-direction is the up-down direction (vertical direction perpendicular to the drawings). The y-direction has a +y-direction (up direction) and the −y-direction (down direction). Herein, the x-direction, the y-direction, and the z-direction are the second direction, the first direction, and the third direction, respectively

Hereinafter, when a certain direction or an axis is “along”, “arranged in”, or “aligned in” a predetermined direction or an axis such as the x-direction, the y-direction, the z-direction, the x-axis, the y-axis, the z-axis, or the like, it is parallel or substantially parallel to the direction or the axis within a manufacturing tolerance of the light source device 1.

Hereinafter, when a certain direction or axis is “perpendicular to” or “orthogonal to” a predetermined direction or an axis such as the x-direction, the y-direction, the z-direction, the x-axis, the y-axis, the z-axis, or the like, it forms a right angle between the certain direction or axis and the other directions or the axes within a manufacturing tolerance of the light source device 1.

As illustrated in FIG. 2, the light source device 1 includes multiple light source modules (a first light source module 10 and a second light source module 20), a prisms 31a, a prism 31b, a color wheel 32, and a light tunnel 33 (light homogenizer).

The light source module (first light source module 10) includes a light source unit 11 in which multiple light sources 11a and multiple collimator lenses 11b corresponding to each of the multiple light sources 11a are integrated, a condenser lens 12 (first condenser lens) of a convex lens to condense a light beam emitted from the light source unit 11, a condenser lens 13 of a concave lens, and a microlens array (MLA) 14, a dichroic mirror 15, a condenser lens 16a, a condenser lens 16b, a condenser lens 18 (second condenser lens), and a phosphor wheel 17 (first phosphor wheel).

The light source unit 11, the condenser lens 12, the condenser lens 13, the microlens array 14, and the dichroic mirror 15 are arranged in this order along the x-direction toward the −x-direction.

The light source 11a is a light source that emits light beam having a first wavelength band (e.g., blue light). The light source 11a includes, for example, a laser diode (LD) that emits a blue laser light beam having a wavelength of around 450 nm. The light source 11a includes multiple light sources arranged in an array, and each of the multiple light sources includes the collimator lens 11b. In other words, the collimator lens 11b includes multiple collimator lenses, which are arranged in an array corresponding to the array of the multiple light sources. The light source 11a is, for example, a single CAN package LD or a multichip LD. In particular, the light source 11a is preferably the multichip LD integrated with the collimator lens. In some embodiments, the light source 11a is a multichip laser module including an LD chip in which a matrix of, for example, 2×7 (two rows×seven columns) of the laser light sources is arranged and the collimator lenses 11b corresponding to each of the multichip.

The multiple light sources 11a emit multiple laser beams to the multiple collimator lenses 11b corresponding to each of the light sources 11a. The multiple laser beams collimated by the multiple collimator lenses 11b enter the condenser lens 12. The condenser lens 12 (first condenser lens) is also a first condenser element. The condenser lens 12 is a light beam reduction element to reduce the light beam and disposed between the light source 11a and the phosphor wheel 17 to be described later. The condenser lens 12 condenses (converges) the light beam to form a thinner light beam having a narrow beam width. The condenser lens 13 is, for example, a condenser lens having a function of light diverging and concave surfaces on both sides of the lens. The concave surfaces are optimized so as to emit the light beam converged by the condenser lens 12 as a substantially parallel light beam while keeping the beam width of the light beam condensed by the condenser lens 12.

The microlens array 14 uniformizes an irradiation density of a spot (irradiation spot) of a light beam. In the microlens array 14, numerous minute lenses are arranged. The microlens array 14 is disposed along the optical axis of the blue light beam 1B emitted from the light source 11a. The blue light beam 1B reaches the microlens array 14 via the condenser lens 12 and the condenser lens 13. The blue light beam 1B emitted from the condenser lens 12 and the condenser lens 13 passes through the microlens array 14 and are condensed.

The dichroic mirror 15 is an optical element that reflects a light beam having a specific wavelength band and transmits a light beam having wavelength bands other than the specific wavelength band. The dichroic mirror 15 is disposed along the optical axis of the blue light beam 1B emitted from the light source 11a via the condenser lens 12, the condenser lens 13 and the microlens array 14, and is disposed so that a mirror surface of the dichroic mirror 15 is inclined with respect to the optical axis of the blue light beam 1B.

The blue light beam 1B condensed by the microlens array 14 is reflected by the dichroic mirror 15 in the back direction (i.e., −z-direction).

In the back direction of the dichroic mirror 15, the condenser lens 16a, the condenser lens 16b, and the phosphor wheel 17 are arranged in this order toward the −z-direction. Herein, the condenser lens 16a and the condenser lens 16b work as the condenser optical system.

The condenser lens 16a and the condenser lens 16b are disposed along the optical axis of the blue light beam 1B passed through the condenser lens 12 and reflected by the dichroic mirror 15. The condenser lens 16a and the condenser lens 16b condense the blue light beam 1B and transmit the blue light beam 1B in the back direction.

The condenser lens 16a and the condenser lens 16b may be used as a single lens, or a combination thereof may be used in the present embodiment. When the condenser lens 16a and the condenser lens 16b have an aspherical surface, the condenser lens 16a and the condenser lens 16b can more condense the blue light beam 1B. In other words, the spot shape of the blue light beam 1B can be smaller.

The phosphor wheel 17 as a first wavelength conversion element is a wavelength conversion element that receives a light beam having a first wavelength band and emits a light beam having a second wavelength band (e.g., yellow light) different from the first wavelength band. The wavelength band is converted by a phosphor, and the phosphor is coated on, for example, the periphery of the substrate on a reflective substrate.

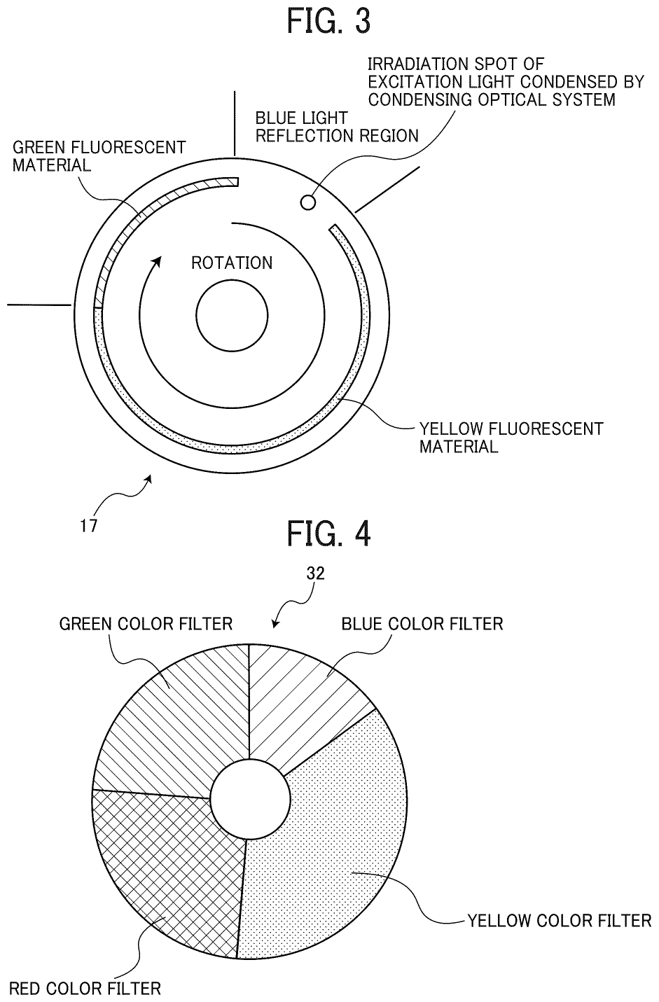

FIG. 3 is a diagram of the phosphor wheel 17. As illustrated in FIG. 3, the phosphor wheel 17 has a phosphor region and a region in which the phosphor does not exist (i.e., no phosphor region). Such a no phosphor region is a region that directly reflects the light beam having the first wavelength band (i.e., reflection region). The phosphor region and the reflection region alternately appear by rotating the phosphor wheel 17.

The phosphor wheel 17 according to the present embodiment is disposed after the condenser lens 16a and the condenser lens 16b in the back direction and in the optical axis of the blue light beam 1B transmitted through the condenser lens 16a and the condenser lens 16b. The phosphor wheel 17 is a circular reflection plate (e.g., disk) to reflect the blue light beam 1B. Phosphors (a first phosphor and a second phosphor) are coated on a portion of a surface of the reflection region on the phosphor wheel 17 along the circumferential direction. For example, in a case where the blue light beam 1B strikes the first phosphor, a green light beam 1G is emitted from the first phosphor, and in a case where the blue light beam 1B strikes the second phosphor, a yellow light beam 1Y is emitted from the second phosphor.

As described above, when the phosphor wheel 17 is rotated by a rotation member such as a motor, the reflection region and the phosphor regions alternately appear. The blue light beam 1B strikes the reflection region and forms a spot on the surface of the reflection surface. The blue light beam 1B is directly reflected in the front direction (i.e., the +z-direction). When the blue light beam 1B strikes the coating surface of the phosphor wheel 17 (the first phosphor or the second phosphor), the green light beam 1G or the yellow light beam 1Y is emitted in the +z-direction. The green light beam 1G and the yellow light beam 1Y are reflected in all directions by the phosphor wheel 17 and become wider than the blue light beam 1B.

The phosphor wheel 17 reflects the blue light beam 1B and emits the green light beam 1G and the yellow light beam 1Y along the +z-direction while rotating. The ratio of the blue light beam 1B, the green light beam 1G, and the yellow light beam 1Y correspond to a ratio of areas of the reflection region, the first phosphor (coating), and the second phosphor (coating). respectively.

The blue light beam 1B, the green light beam 1G, and the yellow light beam 1Y after passing through the condenser lens 16b and the condenser lens 16a pass through the condenser lens 18 as the second condenser element and enter the prism 31a.

As described above, an irradiation spot condensed by the condenser lens 16b and the condenser lens 16a that work as the condenser optical system is formed on the phosphor wheel 17, and the light beam having the second wavelength band is generated by the wavelength conversion property of the phosphor. The irradiation spot works as a secondary light source. The light beam having the second wavelength band is emitted from the secondary light source having the size corresponding to the irradiation spot and is captured again by the condenser lens 16b and the condenser lens 16a. The light beam condensed is guided to the light tunnel 33 by the condenser lens 18. A condensed spot is formed by the condenser lens 16b and the condenser lens 16a at a light entrance (i.e., light incident opening) of the light tunnel 33.

The dichroic mirror 15, the condenser lens 18, the prism 31a, the color wheel 32, and the light tunnel 33 are arranged in this order along +z-direction. The dichroic mirror 15, the condenser lens 16b, and the condenser lens 16a are arranged in this order along −z-direction. Thus, the dichroic mirror 15 is between the condenser lens 18 and the condenser lens 16a.

The prism 31a transmits the blue light beam 1B, the green light beam 1G and the yellow light beam 1Y in the front direction (i.e., +z-direction).

The second light source module 20 is arranged next to the prism 31a in the −x-direction of the prism 31a (the left side of the prism 31a in the drawing). The second light source module 20 has the same configuration as the configuration of the first light source module 10. In the configuration, each member of the first light source module 10 is rotated by 90° with respect to the prism 31a and the prism 31b.

The second light source module 20 includes a light source unit 21 (second light source unit), a condenser lens 22 (first condenser lens), a condenser lens 23, a microlens array 24, a dichroic mirror 25, a condenser lens 26a, a condenser lens 26b, a condenser lens 28 (second condenser lens), and a phosphor wheel 27 (second phosphor wheel). The light source unit 21 includes multiple light sources 21a and multiple collimator lenses 21b corresponding to each of the multiple light sources 21a. The multiple light sources 21a and the multiple collimator lenses 21b are integrated.

The light source unit 21, the condenser lens 22 as the first condenser element, the condenser lens 23, the microlens array 24, and the dichroic mirror 25 are arranged in this order along the z-direction toward the +z-direction.

The light source 21a as the second light source has a configuration corresponding to the light source 11a described above, and is, for example, an LD that emits a blue laser light beam having a wavelength band of around 450 nm.

The multiple light sources 21a emit multiple light beams to the multiple collimator lenses corresponding to each of the multiple light sources 21a, and the multiple light beams after passing through the multiple collimator lenses are collimated (i.e., multiple collimated light beams). The condenser lens 22 condenses the multiple collimated light beams and sends the light beams toward the condenser lens 23. The condenser lens 23 is, for example, a condenser lens having concave surfaces on its both sides and a diverging function. The shape of the concave surfaces are optimized so that a light beam is emitted substantially in parallel while keeping the width of the light beam condensed and thinned by the condenser lens 22.

The microlens array 24 has a configuration corresponding to the microlens array 14 described above and is disposed along the optical axis of the blue light beam 2B emitted from the light source 21a via the condenser lens 22 and the condenser lens 23. The blue light beam 2B emitted from the condenser lens 22 and the condenser lens 23 passes through the microlens array 24 and is condensed.

The dichroic mirror 25 has a configuration corresponding to the dichroic mirror 15 described above and is disposed along the optical axis of the blue light beam 2B emitted from the light source 21a via the condenser lens 22, the condenser lens 23, and the microlens array 24 so that the mirror surface of the dichroic mirror 25 is inclined with respect to the optical axis of the blue light beam 2B.

The blue light beam 2B condensed by the microlens array 24 is reflected in the −x-direction by the dichroic mirror 25.

The condenser lens 26a, the condenser lens 26b and the phosphor wheel 27 are arranged in this order along the −x-direction from the dichroic mirror 25.

The condenser lens 26a and the condenser lens 26b are disposed in the optical axis of the blue light beam 2B reflected by the dichroic mirror 25 and condense the blue light beam 2B. The condenser lens 26a and the condenser lens 26b emit the blue light beam 2B along −x-direction.

The phosphor wheel 27 working as the second wavelength conversion element has a configuration corresponding to the phosphor wheel 17 described above and is disposed in the optical axis of the blue light beam 2B after passing through the condenser lens 26a and the condenser lens 26b. The phosphor wheel 27 is also a reflection plate including a reflection surface of the blue light beam 2B and a coating surface having multiple phosphors.

The phosphor wheel 27 reflects the blue light beam 2B and emits the green light beam 2G and the yellow light beam 2Y along the +x-direction while rotating. The ratio of the blue light beam 2B, the green light beam 2G, and the yellow light beam 2Y corresponds to a ratio of areas of the reflection region, the first phosphor (coating), and the second phosphor (coating).

The blue light beam 2B, the green light beam 2G, and the yellow light beam 2Y after passing through the condenser lens 26b and the condenser lens 26a are condensed, pass through the condenser lens 28 working as the second condenser element, and enter the prism 31b.

The dichroic mirror 25, the condenser lens 28 and the prism 31b are arranged in this order along +x-direction. The dichroic mirror 25, the condenser lens 26a, and the condenser lens 26b are arranged in this order along −x-direction. Thus, the dichroic mirror 25 is between the condenser lens 28 and the condenser lens 26a.

The prism 31b is arranged at a position as the same height with the prism 31a in the z-direction and at a side of the −y-direction. The prism 31b reflects the blue light beam 2B, the green light beam 2G, and the yellow light beam 2Y in the +z-direction.

The blue light beam 2B, the green light beam 2G, and the yellow light beam 2Y reflected by the prism 31b in the +z-direction are combined with the blue light beam 1B, the green light beam 1G, and the yellow light beam 1Y transmitted by the prism 31a in the +z-direction and enter the color wheel 32.

FIG. 4 is a diagram of the color wheel 32. As illustrated in FIG. 4, the color wheel 32 is an optical filter having a disk shape. The color wheel 32 transmits the blue light beam 1B, the blue light beam 2B, the green light beam 1G, the green light beam 2G, the yellow light beam 1Y, and the yellow light beam 2Y. In the color wheel 32, a blue filter, a green filter, a yellow filter, and a red filter are arranged along the circumferential direction. The blue filter transmits the blue light beam 1B and the blue light beam 2B as a light beam having a more uniform wavelength band. The green filter transmits the green light beam 1G and the green light beam 2G as a light beam having a more uniform wavelength band. The yellow filter transmits the yellow light beam 1Y and the yellow light beam 2Y as a light beam having a more uniform wavelength band. The red filter extracts and transmits a red light beam having a substantially uniform wavelength band from the yellow light beam 1Y and the yellow light beam 2Y.

The color wheel 32 rotates so that the blue filter is synchronized with the reflection surface of the blue light beam 1B and the reflection surface of the blue light beam 2B, the green filter is also synchronized with the phosphor coating surface that emits the green light beam 1G of the phosphor wheel 17 and the green light beam 2G of the phosphor wheel 27, and the yellow filter and the red filter are synchronized with the phosphor coating surface that emits the yellow light beam 1Y of the phosphor wheel 17, and the yellow light beam 2Y of the phosphor wheel 27.

The color wheel 32 synchronizes with the phosphor wheel 17 and the phosphor wheel 27 and transmits the blue light beam 1B, the blue light beam 2B, the green light beam 1G, the green light beam 2G, the yellow light beam 1Y, the yellow light beam 2Y, and the red light beam in the +z-direction. The ratio of the blue light beam 1B, the blue light beam 2B, the green light beam 1G, the green light beam 2G, the yellow light beam 1Y, the yellow light beam 2Y, and the red light beam correspond to the ratio of areas of the blue filter, the green filter, the yellow filter, and the red filter. The blue light beam 1B, the blue light beam 2B, the green light beam 1G, the green light beam 2G, the yellow light beam 1Y, the yellow light beam 2Y, and the red light beam emitted from the color wheel enter the light tunnel 33.

The light tunnel 33 working as a light homogenizing element (light homogenizer) is an optical element assembled by four mirrors so to have a shape of a rectangular parallelepiped and extends in the z-direction toward the +z-direction (FIG. 2). The prism 31a, the prism 31b, the color wheel 32, and the light tunnel 33 are arranged in this order along the +z-direction. The light tunnel 33 is not limited to the rectangular parallelepiped assembled by four mirrors described above. For example, a light guide element having a shape of a rectangular parallelepiped made of glass and using the total internal reflection may be used. The light homogenizer may be referred to as a glass rod. In the present embodiment, a light tunnel 33 according to the present embodiment may include the light homogenizer or the glass rod.

The light tunnel 33 has a light entrance (light incident opening) having a rectangle shape at an end face of the light tunnel 33 facing the −z direction. The blue light beam 1B, the blue light beam 2B, the green light beam 1G, the green light beam 2G, the yellow light beam 1Y, the yellow light beam 2Y, and the red light beam enter the light entrance. The light tunnel 33 also has a light exit having a rectangular shape at the opposite end face of the light tunnel 33 facing the −z-direction (i.e., at a side of the color wheel 32). The blue light beam 1B, the blue light beam 2B, the green light beam 1G, the green light beam 2G, the yellow light beam 1Y, the yellow light beam 2Y, and the red light beam passing through the light tunnel 33 exit from the light exit. The light exit may include a light exit opening.

The light after transmitting through the color wheel 32 enters the light tunnel 33, propagates in the light tunnel 33 in the +z-direction while being multiply reflected by the inner surfaces of the four mirrors of the light tunnel 33 and is emitted from the light exit of the light tunnel 33 as a more uniform light beam.

The light beam emitted from the light tunnel 33 enters the illumination optical system 2 (FIG. 1) described above and becomes a light source when the image generation element IM forms an image.

The light source device 1 emits light beams having wavelength bands including red, green, and blue (i.e., three primary colors of light), and the image generation element IM forms images having various colors. Further, the light source device 1 according to the present embodiment adds the yellow light beam 1Y and the yellow light beam 2Y to the blue light beam 1B, the blue light beam 2B, the green light beam 1G, the green light beam 2G, and the red light beam, the brightness of the generated image can be increased.

As described above, the light source device 1 works as the light source in the display apparatus 100 and a light homogenizing device to homogenize the light beam emitted from the light source 11a and the light source 21a and to emit the homogenized light beam to the illumination optical system 2.

In the light source device 1, the condenser lens 18 that condenses the light beam emitted from the light source 11a and emits the light beam to the light tunnel 33 via the prism 31a and the color wheel 32 and the condenser lens 28 that condenses the light beam emitted from the light source 21a and emits the light to a light tunnel 33 via prism 31b and the color wheel 32 are precisely adjusted in the positional relation with the light tunnel 33. Accordingly, the conjugate point of the light beam emitted from the light source device 1 can be precisely aligned with the arrangement position of the image generation element IM.

As described above, the light source device 1 includes the multiple light source modules (i.e., the first light source module 10 and the second light source module 20). The light source device 1 turns the direction of the light beam, which is condensed by the condenser lens 28, emitted from the second light source module 20 to align the direction of the light beam with the other light beam emitted from the first light source module 10 (FIG. 2). As a result, the two light beams propagate in the same direction, and the two light beams are adjacent to each other, overlapped, or superimposed. The configuration of the light source device 1 is not limited thereto. For example, a configuration in which the direction of the light beam emitted from the first light source module 10 is turned may be applied. In the light source device 1, at least the centers of the condensed spots are adjacent to each other.

In some embodiments, a light source device includes: the light source module according to the embodiment; and a light homogenizer having a light incident opening in one end of the light homogenizer in a longitudinal direction of the light homogenizer, the light incident opening having a rectangle shape having a longitudinal side and a lateral side. The light source module according to some embodiments includes: a first light source module to emit a first light beam to the light homogenizer in a fourth direction to form a first light condensed spot at a first position in the light incident opening; a second light source module to emit a second light beam to the light homogenizer in a fifth direction to form a second light condensed spot at a second position adjacent to the first light condensed spot in the light incident opening; and a reflector to bent one of first light beam or the second light beam to align an emission direction of the first light beam and the second light beam to one of the fourth direction or the fifth direction.

Further, the light source device 1 has a configuration in which a light beam incident position of the light tunnel 33 working as a light homogenizer is arranged at a light condensed position.

In the light source device 1, a light beam emitted from the first light source module via the condenser lens 18 may be bent and align the light beam with another light beam emitted from the second light source module 20 via the condenser lens 28. The light source device 1 uses the reflection surface of the prism 31a and the reflection surface of the prism 31b as an element to bend the light beam emitted from the light source module. In FIG. 2, the inclined surface of the prism is used to reflect the light beam emitted from the second light source module 20 so that the direction of the light beam emitted from the second light source module 20 is the same as the direction of the light beam emitted from the first light source module 10.

When the light source device 1 includes the first light source module 10 and the second light source module 20 (i.e., two light source modules), there are two first condenser lenses (the condenser lens 12 and the condenser lens 22) and two second condenser lenses (the condenser lens 18 and the condenser lens 28). The light source device 1 also includes adjusters (e.g., adjustment jigs) to hold each condenser lens separately and to adjust propagation directions of light beams. In each light source module, the first condenser lens and the second condenser lens are perpendicular arranged to each other. The adjuster can adjust the first condenser lens or the second condenser lens in two directions. The two directions are perpendicular to each other and to the propagation direction of light beams. The adjuster may adjust the two directions, or only one direction of the two directions. The first light source module 10 may include two adjuster for the condenser lens 12 and the condenser lens 18 or one adjuster either the condenser lens 12 or the condenser lens 18. The second light source module 20 may include two adjuster for the condenser lens 22 and the condenser lens 28 or one adjuster either the condenser lens 22 or the condenser lens 28.

In some embodiments, a light source module includes: a light source to emit a light beam having a first wavelength band in a first direction; a first condenser lens to condense the light beam emitted from the light source in the first direction; a condenser optical system to condense the light beam from the first condenser lens in a second direction orthogonal to the first direction to form an irradiation spot; a wavelength converter to convert the first wavelength band of the light beam condensed by the condenser optical system into a light beam having a second wavelength band; a second condenser lens to condense the light beam having the second wavelength band converted by the wavelength converter at a predetermined position, a first adjuster to adjust a position of the first condenser lens in at least one of the second direction or a third direction orthogonal to each of the first direction and the second direction; and a second adjuster to adjust a position of the second condenser lens in at least one of the first direction or the third direction.

In some embodiments, the first light source module includes at least one of the first adjuster or the second adjuster, and the second light source module includes at least one of the first adjuster or the second adjuster.

### Configuration Example of Lens Holder and Adjuster of Condenser Lens

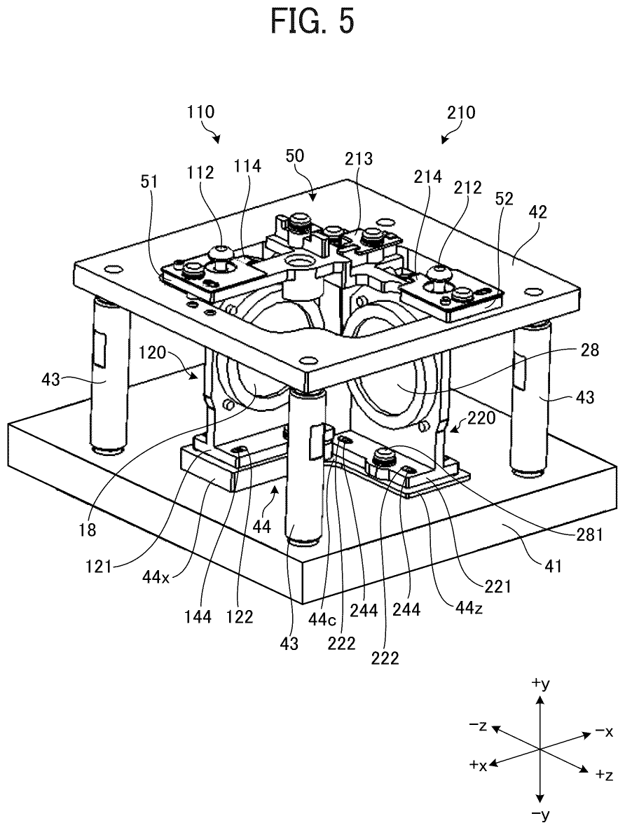

An adjuster to adjust the position of the condenser lens 18 (i.e., a first adjustment portion 110), and another adjuster to adjust the position of the condenser lens 28 (i.e., a second adjustment portion 210) will be described with reference to FIGS. 5 to 9. The second adjuster includes the first adjustment portion 110 and the second adjustment portion 210.

FIG. 5 is a perspective view of the adjusters of the condenser lens 18 and the condenser lens 28 and the peripheral members installed in the light source device 1 according to the present embodiment.

As illustrated in FIG. 5, in the light source device 1, the condenser lens 18 held by a lens holder 120 as a hold member, and the condenser lens 28 is held by a lens holder 220 as a hold member. The condenser lens 18 held by the lens holder 120 and the condenser lens 28 held by the lens holder 220 are housed in a housing (a first housing 41) and another housing (a second housing 42).

The first housing 41 and the second housing 42 are flat plates, and a surface of the first housing 41 and a surface of the second housing 42 in the light source device 1 are parallel to the xz-plane. Multiple posts 43 connect the first housing 41 and the second housing 42 each other. In the light source device 1, the second housing 42 is opposite to the first housing 41 at a position apart from the first housing 41 in the +y-direction.

A base 44 is disposed on a surface of the first housing 41, and the surface is opposed to the second housing 42. The base 44 has a L-shaped shape extending in the x-direction and z-direction. In the base 44, a base portion 44x extending in the x-direction and a base portion 44z extending in the z-direction are arranged to be perpendicular to each other via a connection portion 44c. The base portion 44x is thicker than the base portion 44z.

In some embodiments, in the light source device, further includes an L-shaped base including: a first portion; and a second portion adjacent to and orthogonal to the first portion. The second adjuster of the first light source module is installed on the first portion, and the second adjuster of the second light source module is installed on the second portion.

In some embodiments, in the light source device, the first portion has a first height; and the second portion has a second height different from the first height.

The lens holder 220 to hold the condenser lens 28 is disposed on the base portion 44z extending in the z-direction. The lens holder 220 as the second lens holder includes a frame portion surrounding the condenser lens 28 and a leg portion 221 in contact with the base 44.

The leg portion 221 is fixed to the base portion 44z by a fixing screw 281. The leg portion 221 has multiple guide holes 222 that are elongated holes, and multiple guide pins 244 installed in the base portion 44z are inserted into the guide holes 222, respectively.

The second adjustment portion 210 to adjust the position of the condenser lens 28 in the z-direction is installed at an end portion of the lens holder 220 in the vicinity of the second housing 42. The second adjustment portion 210 includes an adjustment screw 212, an adjustment spring 213, and a press spring 214. The configurations will be described in detail below.

The lens holder 120 to hold the condenser lens 18 is installed on the base portion 44x extending in the x-direction. The lens holder 120 as the first lens holder has the same shape as the lens holder 220. Thus, the lens holder 120 includes a frame portion surrounding the condenser lens 18 and the leg portion 121 in contact with the base portion 44x.

As described above, when the lens holder 120 and the lens holder 220 are housed in the first housing 41 and the second housing 42, the position of the condenser lens 18 and the position of the condenser lens 28 relative to the light tunnel 33 in the y-direction are fixed. As described above, the condenser lens 18 and the condenser lens 28 are disposed in a direction in which the optical axes of the condenser lens 18 and the optical axis of the condenser lens 28 intersect with each other by the lens holder 120 and the lens holder 220 housed in the first housing 41 and the second housing 42.

The thickness of the base portion 44x and the thickness of the base portion 44z are different from each other in the y-direction (i.e., thickness difference). The lens holder 120 is fixed to the base portion 44x, and the lens holder 220 is fixed to the base portion 44z. Thus, in the y-direction, the center of the condenser lens 18 is displaced from the center of the condenser lens 28 toward the +y-direction. The prism 31a and the prism 31b are arranged in this order in the −y-direction (i.e., prism arrangement). The light beam transmitted through the condenser lens 18 enters the prism 31a, and the light beam transmitted through the condenser lens 28 enters the prism 31b because of the thickness difference and the prism arrangement.

The leg portion 121 is fixed to the base portion 44x by a fixing screw. The leg portion 121 has the multiple guide holes 122 that are elongated holes, and the multiple guide pins 144 installed on the base portion 44x are inserted into each of the guide holes 122.

The first adjustment portion 110 to adjust the position of the condenser lens 18 in the x-direction is installed at an end portion of the lens holder 120 in the vicinity of the second housing 42. The first adjustment portion 110 as the first adjustment mechanism is configured similarly to the second adjustment portion 210 and includes an adjustment screw 112, an adjustment spring, and a press spring 114. These configurations will be described later in detail below.

The adjustment screw 112, the adjustment spring, and the press spring 114 in the first adjustment portion 110, and the adjustment screw 212, the adjustment spring, and the press spring 214 in the second adjustment portion 210 are installed in the frame 50 fixed to the second housing 42. The frame 50 includes a frame portion 51 as a first frame and a frame portion 52 as a second frame. The frame portion 51 extends in the x-direction and faces the end face of the second housing 42 of the lens holder 120. The frame portion 52 extends in the z-direction and faces the end face of the second housing 42 of the lens holder 220. The frame portion 51 and the frame portion 52 are perpendicularly arranged to each other and connected so that the end face of the frame portion 51 along the −x-direction and the end face of the frame portion 52 along the +z-direction are adjacent to each other.

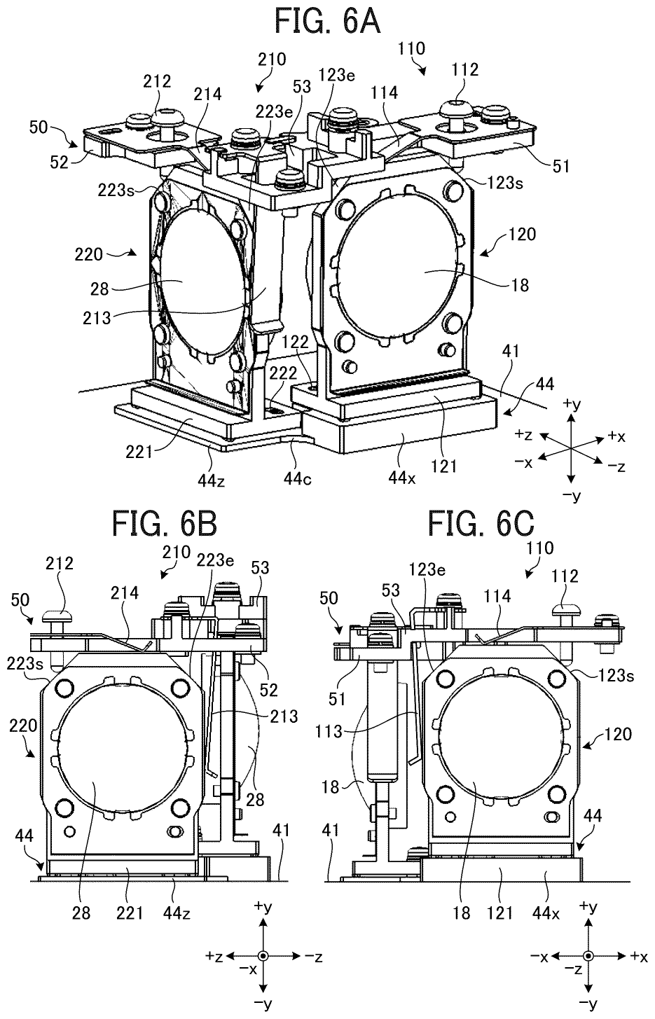

FIGS. 6A to 6C are diagrams of the configuration of the lens holder 120, the lens holder 220, the first adjustment portion 110, and the second adjustment portion 210 according to the present embodiment.

FIG. 6A is a perspective view of the configurations described above. FIG. 6B is a front view of the lens holder 220 as viewed from the −x-direction. FIG. 6C is a front view of the lens holder 120 as viewed from the −z-direction.

As illustrated in FIG. 6C, the lens holder 120 has an end face having a first side extending along the x-direction and facing the +y-direction (first end face), an end face having a fourth side extending along the x-direction and facing the −y-direction (fourth end face), an end face having a second side extending along the y-direction and facing the +x-direction (second end face), and an end face having a third side extending the y-direction and facing the −x-direction (third end face).

The end face facing the +x-direction and the end face facing the −x direction are opposite to each other at both ends in the x-direction of the end face facing +y-direction. In other words, the second end face and the third end face are opposite to each other at the both ends of the first end face. The end face facing the +y-direction and the end face facing the −y-direction are opposed to each other while being separated by the end face facing the +x-direction and the end face facing the −x-direction. In other words, the first end face and the fourth end face are opposite to each other while being separated by the second end face and the third end face.

A frame portion includes the end face facing the +y-direction (first end face), the end face facing the +x-direction (second end face), the end face facing the −x-direction (third end face), and the end face facing the −y-direction (fourth end face). The condenser lens 18 is surrounded by the frame portion of the lens holder 120 so that the optical axis of the condenser lens 18 extends along the z-direction.

The lens holder 120 has an inclination portion 123s inclined with respect to the end face facing the +y-direction (first end face) and the end face facing the +x-direction (second end face). In other words, the inclination portion 123s connects the first end face and the second end face. The lens holder 120 also has an inclination portion 123e inclined with respect to the end face facing the +y-direction (first end face) and the end face facing the −x-direction (third end face). In other words, the inclination portion 123e connects the first end face and the third end face.

Preferably, the inclination portion 123s and the inclination portion 123e are inclined at an angle of 45° or less with respect to the end face facing the +y-direction (first end face) of the lens holder 120. The inclination portion 123s and the inclination portion 123e are also installed at a position away from the center of the condenser lens 180 in the +y-direction.

In the lens holder 120, the leg portion 121 fixed to the base portion 44x of the base 44 is installed on the end face facing the −y-direction (forth end face).

The frame portion 51 of the frame 50 is installed on the end face facing the +y-direction (first end face) of the lens holder 120. In the frame portion 51, the adjustment screw 112, the adjustment spring 113, and a press spring 114 are installed.

The adjustment screw 112 as the first adjustment screw extends to the lens holder 120 from the frame portion 51, and the tip end of the adjustment screw 112 is brought into contact with the inclination portion 123s. The adjustment screw 112 is also attached to the frame portion 51 so that the adjustment screw 112 can move in the extending direction.

The adjustment spring 113 as the first elastic member extends to the lens holder 120 from the frame portion 51 and touches the end face facing −x-direction (third end face) of the lens holder 120. Accordingly, the adjustment spring 113 applies a force to the lens holder 120 so that the force presses the end face facing the −x-direction (third end face) to the +x-direction.

The press spring 114 as the press member extends to the lens holder 120 from the frame portion 51, and touches the end face facing the +y-direction (first end face) of the lens holder 120. Accordingly, the press spring 114 applies a force to the lens holder 120 so that the force press the end face facing the +y-direction (first end face) of the lens holder 120 toward the −y-direction.

As illustrated in FIG. 6B, the lens holder 120 has an end face having a fifth side extending along the z-direction and facing the +y-direction (fifth end face), an end face having an eighth side extending along the z-direction and facing the −y-direction (eighth end face), an end face having a sixth side extending along the y-direction and facing the −z-direction (sixth end face), and an end face having a seventh side extending the y-direction and facing the +z-direction (seventh end face).

The end face facing the +z-direction (seventh end face) and the end face facing the −z direction (sixth end face) are opposite to each other at both ends in the y-direction of the end face facing +y-direction (fifth end face). In other words, the seventh end face and the eighth end face are opposite to each other at the both ends of the fifth end face. The end face facing the +y-direction and the end face facing the −y-direction are opposed to each other while being separated by the end face facing the +z-direction and the end face facing the −z-direction. In other words, the fifth end face and the eighth end face are opposite to each other while being separated by the sixth end face and the seventh end face.

A frame portion includes the end face facing the +y-direction (fifth end face), the end face facing the +z-direction (seventh end face), the end face facing the −z-direction (sixth end face), and the end face facing the −y-direction (eighth end face). The condenser lens 28 is surrounded by the frame portion of the lens holder 220 so that the optical axis of the condenser lens 28 extends along the x-direction.

The lens holder 220 has an inclination portion 223s inclined with respect to the end face facing the +y-direction (fifth end face) and the end face facing the +z-direction (seventh end face). In other words, the inclination portion 223s connects the fifth end face and the seventh end face. The lens holder 220 also has an inclination portion 223e inclined with respect to the end face facing the +y-direction (fifth end face) and the end face facing the −z-direction (sixth end face). In other words, the inclination portion 223e connects the fifth end face and the seventh end face.

Preferably, the inclination portion 223s and the inclination portion 223e are inclined at an angle of 45° or less with respect to the end face facing the +y-direction (fifth end face) of the lens holder 220. Preferably, the inclination portion 223s and the inclination portion 223e are installed at position displaced from the center of the condenser lens 28 along the +y-direction in the y-direction.

In the lens holder 220, the leg portion 221 fixed to the base portion 44z of the base 44 is installed on the end face facing the −y-direction (eighth end face).

The frame portion 52 of the frame 50 is installed on the end face facing the +y-direction (fifth end face) of the lens holder 220. In the frame portion 52, an adjustment screw 212, an adjustment spring 213, and a press spring 214 are installed.

The adjustment screw 212 as the second adjustment screw extends to the lens holder 220 from the frame portion 52, and the tip end the adjustment screw 212 touches the inclination portion 223s. The adjustment screw 212 is also attached to the frame portion 52 so that the adjustment screw 212 can move in the extending direction.

The adjustment spring 213 as the second elastic member extends to the lens holder 220 from the frame portion 52 and touches the end face facing −z-direction (sixth end face) of the lens holder 220. Accordingly, the adjustment spring 213 applies a force to the lens holder 220 so that the force presses the end face facing the −z-direction (sixth end face) to the +z-direction.

The press spring 214 as the press member extends to the lens holder 220 from the frame portion 52, and touches an end face of facing the +y-direction (fifth end face) of the lens holder 220. Accordingly, the press spring 214 applies a force to the lens holder 220 so that the force press the end face facing the +y-direction (fifth end face) of the lens holder 220 toward the −y-direction.

As illustrated in FIGS. 6A and 6C, the lens holder 120 is in a state housed in the first housing 41 and the second housing 42 and is adjacent to the lens holder 220 at the end surface which the adjustment spring 113 touches. As illustrated in FIGS. 6A and 6B, the lens holder 220 is in a state housed in the first housing 41 and the second housing 42 and the lens holder 220 is adjacent to the lens holder 120 at the end surface which the adjustment spring 213 touches.

The frame 50 installed on the end face of the lens holder 120 and the end face of the lens holder 220 facing the +y-direction has a configuration in which the frame portion 51 extending in the x-direction and facing the end face of the lens holder 120 facing the +y-direction and the frame portion 52 extending in the z-direction and facing the end face of the lens holder 220 facing the +y-direction are connected by the connection portion 53.

As described above, since the lens holder 120 and the lens holder 220 are installed on the base portion 44x and the base portion 44z having a different thicknesses (height) from the thickness (height) of the base portion 44x, the connection portion 53 of the frame 50 has also a step.

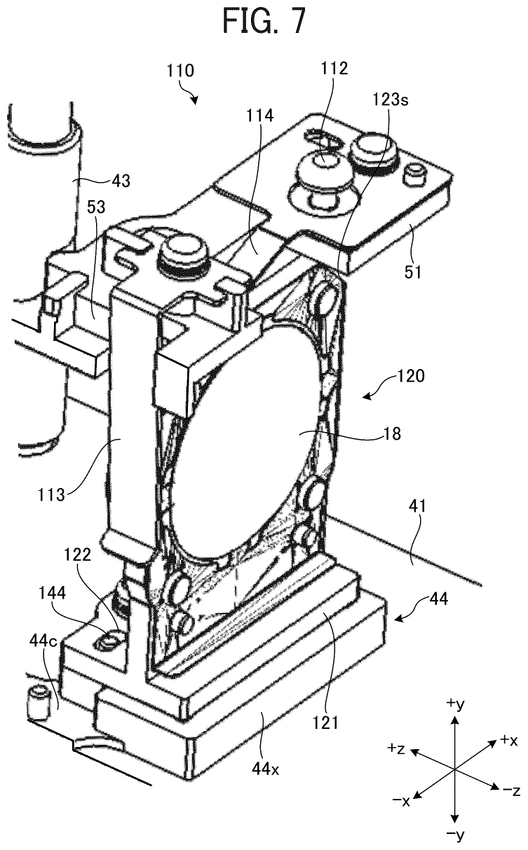

FIG. 7 is a perspective view of the configuration of the lens holder 120 and the first adjustment portion 110 according to the present embodiment. In FIG. 7, the angle of the perspective view is easy to recognize the adjustment spring 113 and the press spring 114 of the first adjustment portion 110 installed in the lens holder 120.

In FIG. 7, a cross section of the frame portion 51 connected to the frame portion 52 is illustrated.

As illustrated in FIG. 7, an end portion of the adjustment spring 113 in the +y-direction is fixed to the upper surface of the frame portion 51 with a screw. The adjustment spring 113 penetrates through the frame portion 51 from the upper surface of the frame portion 51 and extends along the end face facing the −x-direction (third end face) of the lens holder 120, and the end portion facing the −y-direction touches the end face facing the −x-direction (third end face).

An end portion of the press spring 114 in the +y-direction is fixed to the upper surface of the frame portion 51 with a screw. The press spring 114 penetrates through the frame portion 51 from the upper surface of the frame portion 51, and touches the end face facing the +y-direction (first end face) of the lens holder 120.

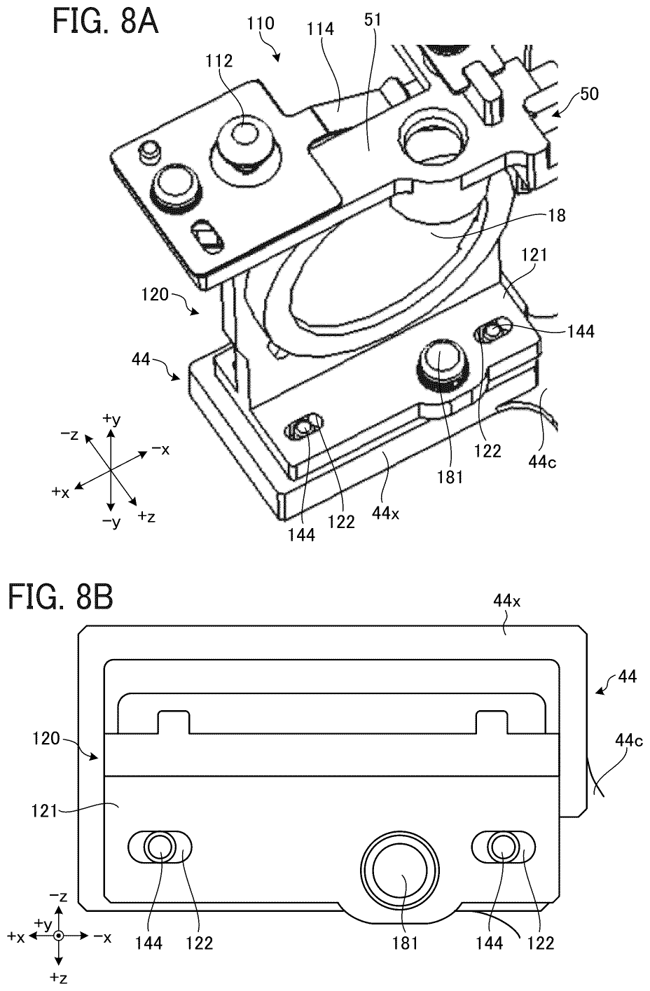

FIGS. 8A and 8B are diagrams of the configuration of the back side of the lens holder 120. In FIGS. 8A and 8B, the configuration of the back side of the lens holder 120 is an example according to the present embodiment. FIG. 8A is a perspective view of the lens holder 120, and FIG. 8B is a top view of the lens holder 120 as viewed from the +y-direction.

As illustrated in FIGS. 8A and 8B, the leg portion 121 extends in the +z-direction and the −z-direction via the frame portion of the lens holder 120, and a portion of the leg portion 121 on the +z-direction side is fixed to the base portion 44x of the base 44 by the fixing screw 181 working as a fixing member.

However, the fix member to fix the lens holder 120 to the base portion 44x may be, for example, an adhesive. In such a case, the lens holder 120 may be fixed to the base portion 44x by applying an adhesive between the contact surface of the leg portion 121 with the base portion 44x and the base portion 44x.

The multiple guide holes 122 are installed at a side of the +z-direction and apart from each other along the x-direction. The multiple guide holes 122 are formed as elongated holes in which the longitudinal direction of the elongated hole is along the x-direction. The guide pins 144 installed on the base portion 44x are inserted into the guide holes 122.

In the lens holder 120 described above, the position of the lens holder 120 in the x-direction with respect to the light tunnel 33 is adjusted by the first adjustment portion 110 described above. The way of adjustment will be described below.

The lens holder 120 holding the condenser lens 18 is housed in the first housing 41 and the second housing 42 without being fixed by the fixing screw 181. The guide pin 144 of the base portion 44x is inserted into the guide hole 122 installed in the leg portion 121 of the lens holder 120. The lens holder 120 can move in the first housing 41 and the second housing 42 in the x-direction by the length of the guide hole 122 in the longitudinal direction.

In this state, when the lens holder 120 is to be moved in the −x-direction, the adjustment screw 112 is pressed out in the −y-direction. The tip end of the adjustment screw 112 touches the inclination portion 123s facing the +x-direction of the lens holder 120. Since the adjustment screw 112 is pressed out along the −y-direction, a force to press along the −y-direction works on the inclination portion 123s, and a force to press along the −x-direction also works on the inclination portion 123s. In other words, the force applied to the inclination portion 123s from the adjustment screw 112 includes a vector component in the −y-direction and a vector component in the −x-direction.

Accordingly, the lens holder 120 entirely moves in the −x-direction via the inclination portion 123s. As described above, for example, when the inclination portion 123s is inclined at 45° or less with respect to the end face of the lens holder 120 in the +y-direction, the amount of movement of the lens holder 120 in the −x-direction is smaller than the amount of the extrusion of the adjustment screw 112 in the −y-direction.

By contrast, when the lens holder 120 moves in the +x-direction, the adjustment screw 112 is pulled up along the +y-direction. Accordingly, the force applied from the adjustment screw 112 to the inclination portion 123s is removed.

The adjustment spring 113 touches the end face of the lens holder 120 facing the −x-direction (third end face), and a force to push the end face facing the −x direction toward the +x-direction is applied by the adjustment spring 113. As described above, the lens holder 120 can entirely be moved in the +x-direction via the end face facing the −x-direction by removing the force applied to the inclination portion 123s from the adjustment screw 112.

A press spring 114 touches the end face facing the +y-direction (first end face) of the lens holder 120. Accordingly, the press spring 114 applies a force to the lens holder 120 so that the force press the end face facing the +y-direction (first end face) of the lens holder 120 toward the −y-direction.

As described above, since the lens holder 120 is pressed against the first housing 41 by the press spring 114, even when a force is applied by the adjustment screw 112 and the adjustment spring 113, the lens holder 120 is prevented from rotating and moving away from the direction along the z-direction, for example.

After the adjustment of the position of the lens holder 120 in the x-direction by the adjustment screw 112 and the adjustment spring 113 is finished, the leg portion 121 of the lens holder 120 is fixed to the base portion 44x by the fixing screw 181. Accordingly, the position of the lens holder 120 adjusted in the x-direction is determined.

The lens holder 220 to hold the condenser lens 28 and the second adjustment portion 210 to adjust the position of the condenser lens 28 are also configured similarly to the lens holder 120 and the first adjustment portion 110 as described above.

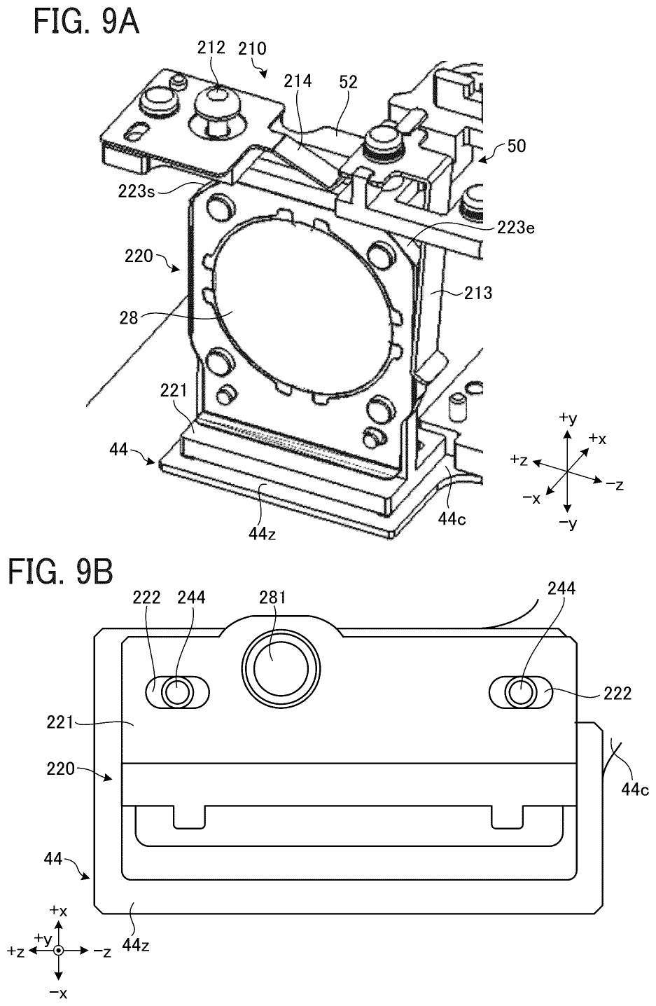

FIGS. 9A and 9B are diagrams of the configuration of the lens holder 220 according to the present embodiment. FIG. 9A is a perspective view of the lens holder 220, and FIG. 9B is a top view of the lens holder 220 as viewed from the +y-direction.

As illustrated in FIG. 9A, the adjustment screw 212 touches the inclination portion 223s of the lens holder 220 that is the opposite side adjacent to the lens holder 120.

An end portion of the adjustment spring 213 in the +y-direction is fixed to the upper surface of the frame portion 52 with a screw. The adjustment spring 213 penetrates through the frame portion 52 from the upper surface of the frame portion 52 and extends along the end face facing the −x-direction (sixth end face) of the lens holder 220 that adjacent to the lens holder 120, and the end portion facing the −y-direction touches the end face facing the −z-direction (fifth end face).

The end portion of the press spring 214 in the +y-direction is fixed to the upper surface of the frame portion 52 with a screw. The press spring 214 penetrates the frame portion 52 from the upper surface of the frame portion 52, and touches the end face of the lens holder 220 facing the +y-direction.

As illustrated in FIG. 9B, in the leg portion 221 extending to the +x-direction and the −x-direction via the frame portion of the lens holder 220, a portion of the leg portion 221 facing the +x-direction is fixed to the base portion 44z of the base 44 by a fixing screw 281 working as a fixing member.

The fix member to fix the lens holder 220 to the base portion 44z may be, for example, an adhesive. In such a case, the lens holder 220 may be fixed to the base portion 44z with an adhesive between the contact surface of the leg portion 221 of the base portion 44z and the base portion 44z.

The multiple guide holes 222 are installed at a side of the +x-direction and apart from each other along the z-direction. The guide holes 222 are formed as elongated holes in which the longitudinal direction of the elongated hole is along the x-direction. The guide pins 244 installed on the base portion 44z are inserted into the guide holes 222.

In the lens holder 220 described above, the position of the lens holder 220 in the z-direction with respect to the light tunnel 33 is adjusted by the second adjustment portion 210 described above. The way of adjustment will be described below.

The lens holder 220 holding the condenser lens 28 is housed in the first housing 41 and the second housing 42 without being fixed by the fixing screw 281. The guide pin 244 of the base portion 44z is inserted into the guide hole 222 installed in the leg portion 221 of the lens holder 220. The lens holder 220 can move in the first housing 41 and the second housing 42 in the z-direction by the length of the guide hole 222 in the longitudinal direction.

In this state, when the lens holder 220 moves in the −z-direction, the adjustment screw 212 is pressed out along the −y-direction. The tip end of the adjustment screw 212 touches the inclination portion 223s facing the +z-direction of the lens holder 220.

Since the adjustment screw 212 is pressed out along the −y-direction, a force to press along the −y-direction works on the inclination portion 223s, and a force to press along the −z-direction also works on the inclination portion 223s. In other words, the force applied to the inclination portion 223s from the adjustment screw 212 includes a vector component in the −y-direction and a vector component in the −z-direction.

Accordingly, the lens holder 220 entirely moves in the −z-direction via the inclination portion 223s. As described above, for example, when the inclination portion 223s is inclined at 45° or less with respect to the end face of the lens holder 220 in the +y-direction, the amount of movement of the lens holder 220 in the −y-direction is smaller than the amount of the extrusion of the adjustment screw 212 in the −z-direction.

By contrast, when the lens holder 220 moves in the +z-direction, the adjustment screw 212 is pulled up along the +y-direction. Accordingly, the force applied from the adjustment screw 212 to the inclination portion 223s is removed.

The adjustment spring 213 touches the end face of the lens holder 220 facing the −z-direction (sixth end face), and a force to press the end face facing the −z direction toward the +z-direction is applied by the adjustment spring 213. As described above, the lens holder 220 can be entirely moved in the +z-direction via the end face facing the −z-direction by removing the force applied to the inclination portion 223s from the adjustment screw 212.

A press spring 214 touches the end face facing the +y-direction (fifth end face) of the lens holder 220. Accordingly, the press spring 214 applies a force to the lens holder 220 so that the force press the end face facing the +y-direction (fifth end face) of the lens holder 220 toward the −y-direction.

As described above, since the lens holder 220 is pressed against the first housing 41 by the press spring 214, even when a force is applied by the adjustment screw 212 and the adjustment spring 213, the lens holder 220 is prevented from rotating and moving away from the direction along the z-direction, for example.

After the adjustment of the position of the lens holder 220 in the z-direction by the adjustment screw 212 and the adjustment spring 213 is finished, the leg portion 221 of the lens holder 220 is fixed to the base portion 44z by the fixing screw 281. The position of the lens holder 220 adjusted in the z-direction is determined.

In the above description, for the sake of convenience, the inclination portion 123s and the inclination portion 123e of the lens holder 120 are distinguished from each other, and the inclination portion 223s and the inclination portion 223e of the lens holder 220 are also distinguished from each other. However, for example, there is no difference among these inclination portions 123s, 123e, 223s, and 223e in the shape and configuration. As described above, the lens holder 120 and the lens holder 220 have the same shape as each other.

In a display apparatus such as a projector, since a laser light beam emitted from a light source enters a light tunnel, the position of a condenser lens disposed in the vicinity of the light tunnel may be adjusted. However, when the number of parts of the adjuster is large, the size of the entire light source apparatus becomes larger.

In the light source device 1 according to the present embodiment, the first adjustment portion 110 includes an adjustment screw 112 attached to the frame portion 51 to move in an extension direction from the frame portion 51 to the lens holder 120, in which the tip end portion of the adjustment screw touches an inclination portion 123s, and the adjustment spring 113 extending to the lens holder 120 from the frame portion 51 and being in contact with an end surface of the lens holder 120 facing −x-direction. Accordingly, the position of the lens can be adjusted with higher precision with a small number of parts, elements, members, or portions.

In some embodiments, in the light source device, the second adjuster is to adjust the position of the second condenser lens in the third direction.

In the light source device 1 according to the present embodiment, the inclination portion 123s of the lens holder 120 is inclined at an angle of 45° or less with respect to the end face of the lens holder 120 facing the +y-direction (first end face). Accordingly, the amount of movement of the lens holder 120 in the −x-direction is smaller than the amount of extrusion of the adjustment screw 112 in the −y-direction. Thus, the adjustment sensitivity of the position of the lens holder 120 in the x-direction can be enhanced, and the position of the condenser lens 18 can be aligned more precisely.

In the light source device 1 according to the present embodiments, the inclination portion 123s of the lens holder is installed at a position away from the center of the condenser lens held by the lens holder 120 along the y-direction and closer to the end face of the lens holder 120 facing the +y-direction. Accordingly, the inclination portion 123s of the lens holder 120 has a shape following the outer shape of the condenser lens 18. Thus, the lens holder 120 and the first adjustment portion 110 can be reduced in size.

The light source device 1 according to the present embodiment, the first adjustment portion 110 further includes a press spring 114 that extends to the lens holder 120 from the frame portion 51 and touches the end face of the lens holder 120 along the +y-direction. Accordingly, while adjusting the position of the lens holder 120 in the x-direction, the lens holder 120 is prevented from rotating due to the force applied from the adjustment screw 112 and the adjustment spring 113.

In the light source device 1 according to the present embodiment, the lens holder 120 has the guide hole 222 that is installed in the leg portion 121 and whose longitudinal direction is along the direction in which the end face facing the +y-direction (first end face), of the lens holder 120 extends, and the base portion 44x has the guide pin 144 that is inserted into the guide hole 122. Thus, the lens holder 120 can move in the x-direction when the position of the lens holder 120 is adjusted.

In the light source device 1 according to the present embodiment, the leg portion 121 of the lens holder 120 is fixed to the first housing 41 by the fixing screw 181. Thus, the lens holder 120 after the position adjustment is fixed to the first housing 41, and the adjustment position of the lens holder 120 is determined.

In the light source device 1 according to the present embodiment, the condenser lens 18 is housed in the first housing 41 and the second housing 42 via the lens holder 120, and the condenser lens 28 is housed in the first housing 41 and the second housing 42 via the lens holder 220 so that the optical axis of the condenser lens 18 and the optical axis of the condenser lens 28 are perpendicular to each other. Further space saving can be achieved by housing the condenser lens 18 and the condenser lens 28 together in the first housing 41 and the second housing 42.

In the light source device 1 according to the present embodiment, the lens holder 120 and the lens holder 220 are fixed to the base 44 of the first housing 41, and the base portion 44x to which the lens holder 120 is fixed is thicker than the base portion 44z to which the lens holder 220 is fixed. Thus, the optical axis of the condenser lens 18 and the optical axis of the condenser lens 28 are shifted from each other in the y-direction, and the light beam emitted from the condenser lens 18 and the light beam emitted from the condenser lens 28 enter the prism 31a and the prism 31b, respectively.

In the light source device 1 according to the embodiment, the lens holder 120 and the lens holder 220 are housed in the first housing 41 and the second housing 42 so that the end face which the adjustment spring 113 of the lens holder 120 touches and the end face which the adjustment spring 213 of the lens holder 220 touches are adjacent to each other. Accordingly, the adjustment screw 112 and the adjustment screw 212 are separated from each other, and the adjustment screw 112 and the adjustment screw 212 are easy to pull and push in adjustment.

In the light source device 1 according to the present embodiment, the lens holder 120 and the lens holder 220 have the same shape. The lens holder 120 has an inclination portion 123e, and the lens holder 220 has an inclination portion 223e. In the lens holder 120, the inclination portion 123e is inclined to the end face facing the +y-direction (first end face) and the end face which the adjustment spring 113 touches, and the inclination portion 223e is inclined to the end face facing the +y-direction (fifth end face) and in the lens holder 220, the end face which the adjustment spring 113 touches. Accordingly, the lens holder 120 with respect to the condenser lens 18 and the lens holder 220 with respect to the condenser lens 28 are commonly used, and the number of parts can be reduced, and the cost of the light source device 1 can be reduced.

### Configuration Example of Lens Holder and Adjuster of Condenser Lens

A lens holder 600 as a hold member to hold the condenser lens 12 and the condenser lens 22 will be described. In the following description, the case where the lens holder 600 holds the condenser lens 12 is described as an example, but the case where the lens holder 600 holds the condenser lens 22 is also the same.

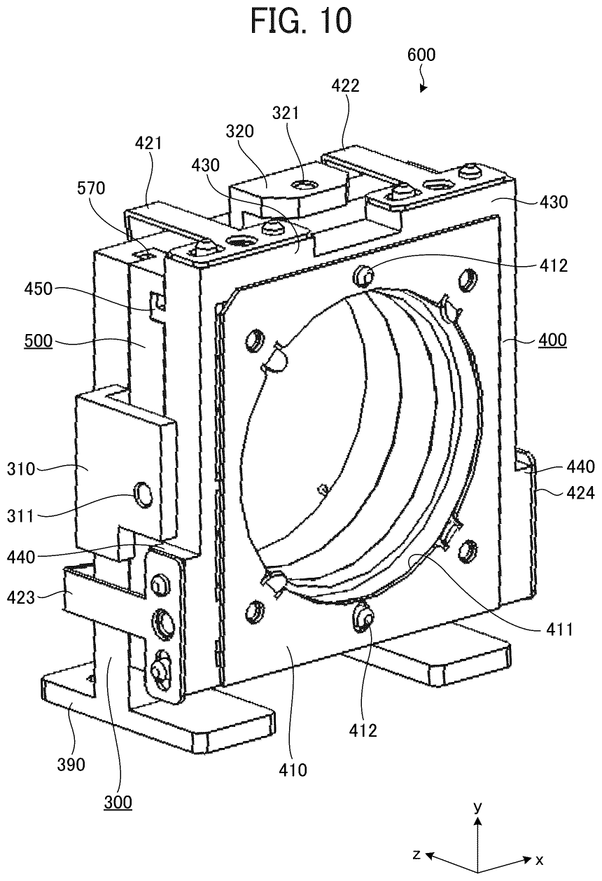

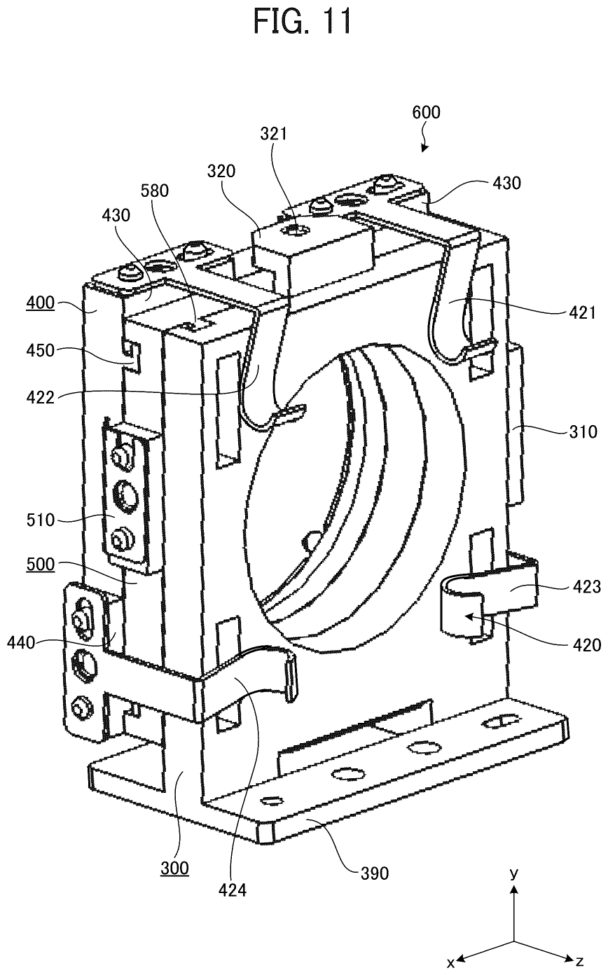

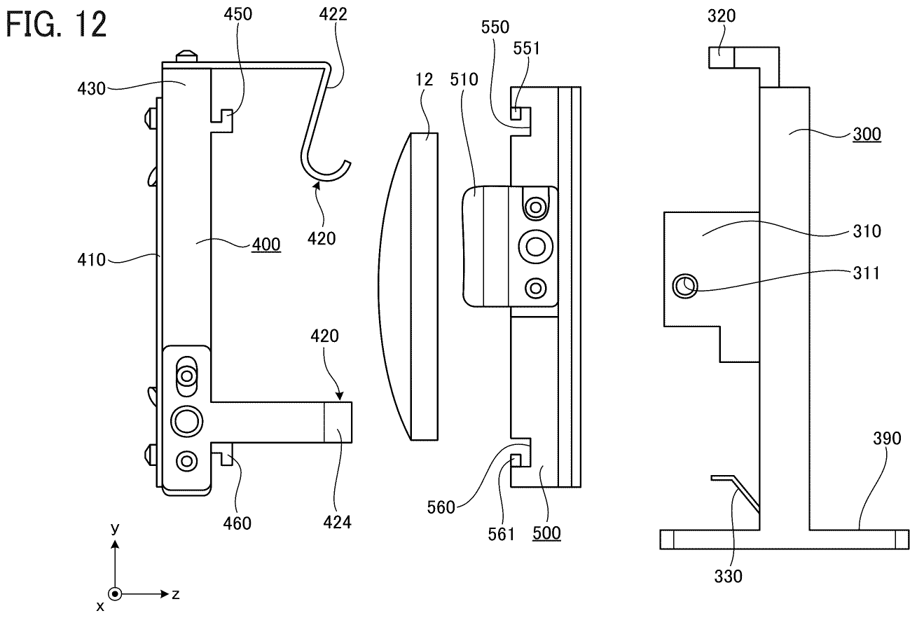

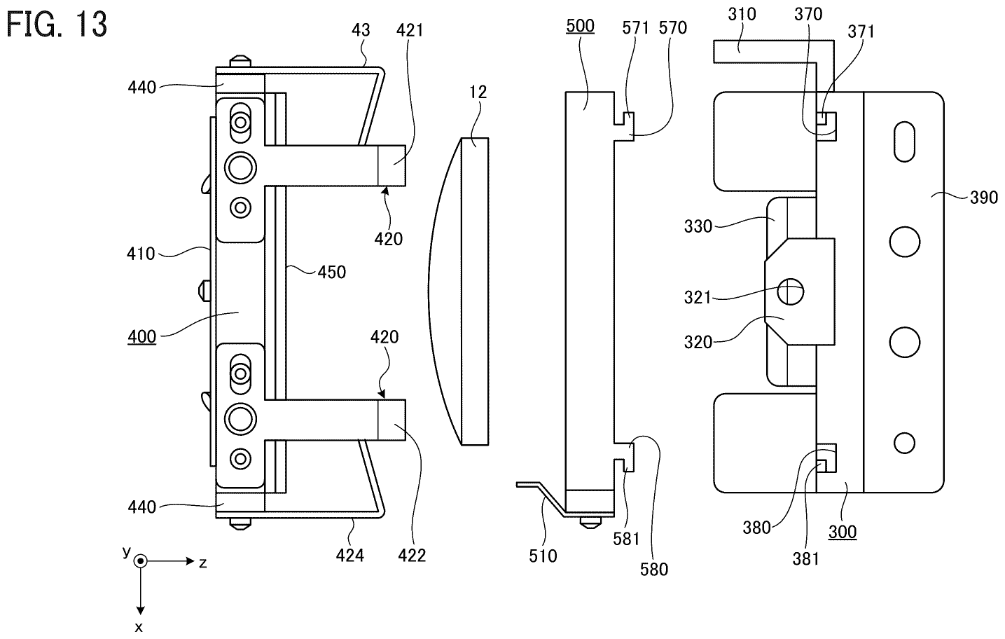

FIGS. 10 and 11 are diagrams of the appearance of the lens holder 600. FIGS. 12 and 13 are exploded views of the lens holder 600. FIG. 12 is a right side view, and FIG. 13 is a plan view. The three-dimensional coordinate system is also illustrated in the drawings. In the drawings, the x-direction (x-axis, horizontal direction of the optical system) is defined as a width direction (right-left direction) of the lens holder 600, the y-direction (y-axis, vertical direction of the optical system) is defined as a height direction (up-down direction) of the lens holder 600, and the z-direction (z-axis, direction of the optical axis of the optical system) is defined as a thickness direction (depth direction, front-back direction) of the lens holder 600. The z-direction is the direction of the optical axis of the optical system, the x-direction and the y-direction are perpendicular to each other and to the z-direction. FIG. 10 is a perspective view of the lens holder 600 as viewed from the front side (light incident side), and FIG. 11 is a perspective view of the lens holder 600 as viewed from the opposite side (back side) in FIG. 10.

The lens holder 600 includes a first holder 400, a second holder 500, and a holder base 300. The holder base 300 is fixed to the casing member of the light source device 1. The first holder 400 is a member to which the condenser lens 12 is attached. The second holder 500 is disposed between the first holder 400 and the holder base 300, and the first holder 400 is attached to the holder base 300.

The first holder 400 surrounds the outer periphery of the condenser lens 12 and holds the condenser lens 12. The second holder 500 has a frame shape that can pass the light beam after passing through the condenser lens 12 held by the first holder 400. The holder base 300 has a frame shape that can pass the light beam after passing through the second holder 500.

The second holder 500 holds the first holder 400 so as to move the first holder 400 in the x-direction (width direction). Herein, the x-direction or the width direction is referred to as a first direction as an example. The holder base 300 holds the second holder 500 so as to move the second holder 500 in the y-direction (height direction). Herein, the y-direction or the up-down direction is referred to as the second direction as an example. Accordingly, the position of the condenser lens 12 can be adjusted in two axes (i.e., the first direction and the second direction) with respect to the holder base 300.

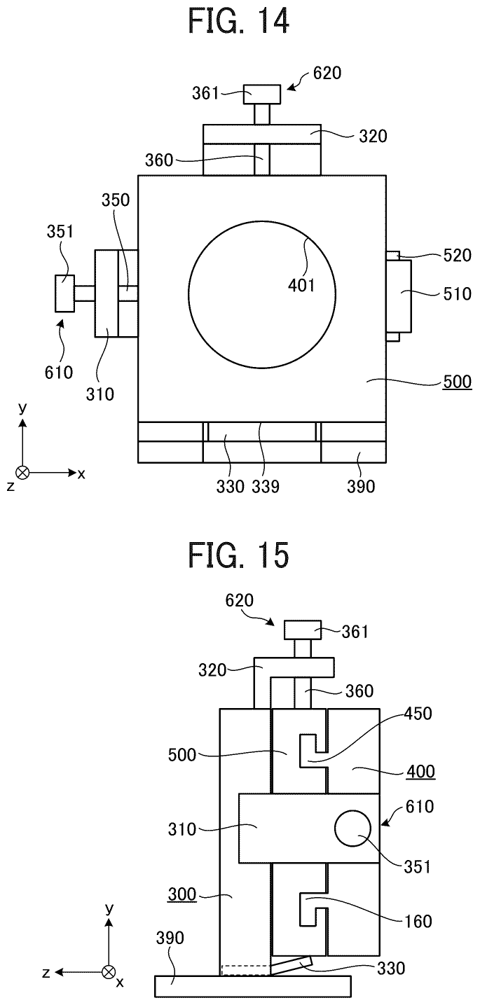

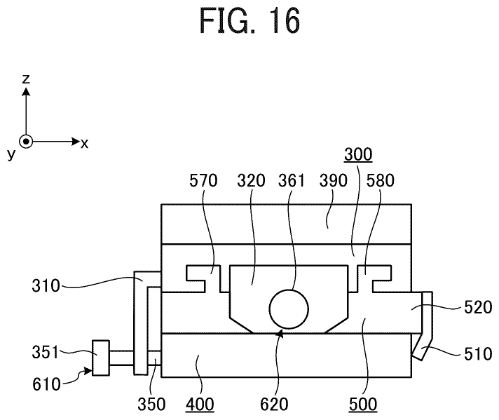

Among the condenser lens 12, the condenser lens 16a, the condenser lens 16b, the condenser lens 18, the condenser lens 22, the condenser lens 26a, the condenser lens 26b, and the condenser lens 28 in the light source device 1, the condenser lens 12 just after the light source 11a and the condenser lens 22 just after the light source 12a are positioned with particularly higher accuracy as compared with other condenser lenses described above. The lens holder 600 holds the condenser lens 12 so as to adjust the position in two axes (two directions) at the installed position. The lens holder 600 also holds the condenser lens 22 so as to adjust the position in two axes (two directions) at the installed position. The positional relation between the adjustment member (first adjustment member 610 and second adjustment member 620) related to the adjustment described above and other members is illustrated in FIG. 14 to FIG. 16. FIG. 14 is a front view, FIG. 15 is a side view, and FIG. 16 is a plan view of the adjustment member.

FIGS. 14 to 16 are diagrams of the configurations and the functions of the first adjustment member 610 and the second adjustment member 620. The lens holder 600 further includes the first adjustment member 610 and the second adjustment member 620. The first adjustment member 610 includes a first adjustment screw 350, a first screw hold portion 310, a first biasing member 510 and may include other members (i.e., the lens holder 600 is the first adjuster). The second adjustment member 620 includes a second adjusting screw 360, a second screw hold portion 320, a second biasing member 330, and may include other members.

The first screw hold portion 310 is installed so as to protrude from the edge of the holder base 300 and has a screw hole 311, and holds the first adjustment screw 350 screwed into the screw hole 311. In the first adjustment screw 350, its axial direction is directed to the first direction (x-direction), and the tip of the first adjustment screw 350 is touches the outer peripheral surface of the first holder 400. The first biasing member 510 is, for example, a plate spring, and presses the outer peripheral surface of the first holder 400 from the opposite side which the first adjustment screw 350 touches. The biasing direction of the first biasing member 510 is along the +x-direction. When the first adjustment screw 350 is screwed in, the first holder 400 moves in the −x-axis against the biasing force of the first biasing member 510.

The first adjustment member 610 adjusts the position of the condenser lens 12 in the x-direction by moving the first holder 400 in the x-direction (width direction) with respect to the holder base 300 and the second holder 500 by the functions of some members described above. Herein, the first direction is substantially orthogonal to a direction in which the holder base 300, the first holder 400, and the second holder 500 are assembled (assembled direction, z-direction).

Similarly, the second screw hold portion 320 is installed so as to protrude from the edge of the holder base 300 and has a screw hole 321, and holds the second adjustment screw 360 screwed into the screw hole 321. In the second adjustment screw 360, its axial direction is directed to the second direction (y-direction), and the tip of the second adjustment screw 360 touches the outer peripheral surface of the second holder 500. The second biasing member 330 is, for example, a plate spring and presses the outer peripheral surface of the second holder 500 from the opposite side which the second adjustment screw 360 touches. The biasing direction of the second biasing member 330 is the +y-direction (up direction). When the second adjustment screw 360 is screwed in, the second holder 500 moves in the −y-direction (down direction) against the biasing force of the second biasing member 330.

The second adjustment member 620 adjusts the position of the condenser lens 12 in the y-direction by moving the second holder 500 with respect to the holder base 300 in the up direction (y-direction), which is the second direction substantially orthogonal to the assembled direction and the first direction (x-direction).

The casing of the light source device 1 has a hole to expose the head portion 351 of the first adjustment screw 350 so as to access from outside the casing and a hole to expose the head portion 361 of the second adjustment screw 360 so as to access from outside the casing.

In FIG. 11, the lens holder 600 further includes a spring 421, a spring 422, a spring 423, and a spring 424 that work as a hold portion 420. The springs 421 to 424 hold the first holder 400, the second holder 500, and the holder base 300, which are assembled in the thickness direction (z-direction), in a state of being held from the outer peripheral, and urge the first holder 400, the second holder 500, and the holder base 300 to come close to each other along the assembled direction. Accordingly, the springs 421 to 424 (i.e., the hold portion 420) hold the adjusting state by the first adjustment member 610 and the second adjustment member 620.

One end of each of the springs 421 to 424 is fixed to the first holder 400, and the other end thereof goes around and presses the surface of the holder base 300 opposite to the surface touching the second holder 500. The hold portion 420 is installed at least at multiple positions of the upper portion and both side portions of the first holder 400.

As illustrated in FIGS. 12 and 13, the spring 421 and the spring 422 are bent in a substantially L-shape in a side view. One end portion (i.e., root portion) of the spring 421 and the spring 422 are fixed to the upper surface of the first holder 400, and the other end portion (i.e., tip portion) thereof presses the back surface of the holder base 300. As illustrated in FIGS. 10 to 13, the spring 423 and the spring 424 are bent in a substantially L-shape in a plan view. One end portion (i.e., root portion) of the spring 423 and the spring 424 are fixed to the side surface of the first holder 400, and the other end (i.e., tip portion) presses the back surface of the holder base 300.

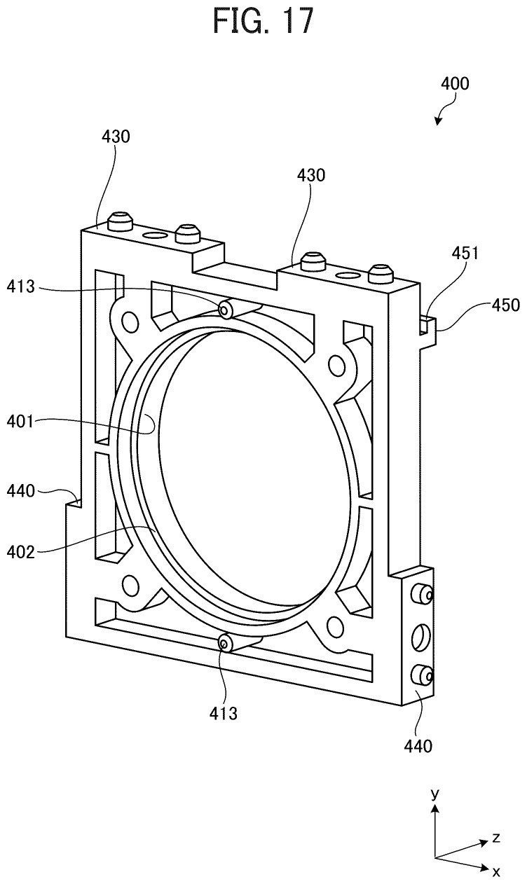

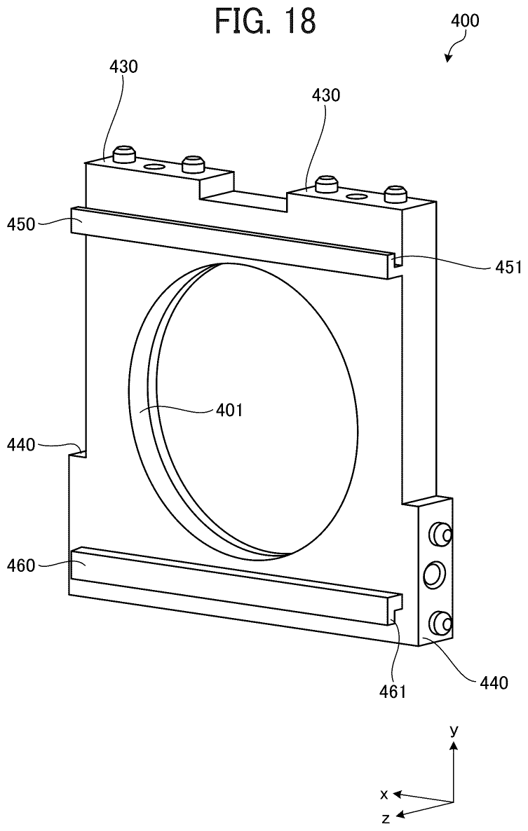

FIGS. 17 and 18 are diagrams of the appearance of the first holder 400. FIG. 17 is a perspective view of the first holder 400 as viewed from the front side, and FIG. 18 is a perspective view as viewed from the back side. The first holder 400 has an appearance of a substantially rectangular plate and a hole 401 having a diameter similar to the diameter of the condenser lens 12 at the center of the first holder 400. As viewed from the front side (FIG. 17), the hole 401 has a step 402 by having a larger-diameter hole and a smaller-diameter hole adjacent to each other from the front side to the back side. The outer peripheral portion of the flat surface on the inner side of the condenser lens 12 is pressed by the step 402, and the curved surface on the front side of the condenser lens 12 is pressed by the cover 410.

As illustrated in FIG. 10, the cover 410 has a hole 411 at the center to expose the curved surface of the condenser lens 12, and is fixed to the front surface of the first holder 400 with screws 412. The condenser lens 12 is disposed between the cover 410 and the step 402.

The first holder 400 includes attachment portions 430 to which the spring 421 and the spring 422 are attached at two positions on the upper surface, and further includes the attachment portions 440 to which the spring 423 and the spring 424 are attached on the left and right side surfaces. The attachment portions 430 and 440 are installed so as to protrude from the outer peripheral surface (upper surface and side surface) of the first holder 400. Since the root portions of the springs 421 to 424 are fixed to the attachment portions 430 and 440, the springs 421 to 424 are separated from the outer peripheral portions (upper surface and side surface) of the first holder 400, the second holder 500, and the holder base 300.

The first holder 400 further includes a first rail 450, a first rail 460, a first hook portion 451, and a first hook portion 461 on the back side (FIG. 18). The first rail 450 protrudes from the back surface of the first holder 400 in the thickness direction (z-direction), and is installed so that the longitudinal direction thereof is along the width direction (x-direction, first direction). The first rail 460 protrudes from the back surface of the first holder 400 in the thickness direction (z-direction), and is installed so that the longitudinal direction thereof is along the width direction (x-direction, first direction). The first hook portion 451 is installed by bending from the protruding direction (z-direction) of the first rail 450, and together with the first rail 450 forms a substantially L-shape in a longitudinal side surface (yz-section). The first hook portion 461 is installed by bending from the protruding direction (z-direction) of the first rail 460, and together with the first rail 460, forms a substantially L-shape in a longitudinal side surface (yz-section). The first rail 450, the first rail 460, the first hook portion 451, and the first hook portion 461 respectively cooperate with the first groove 550, the first groove 560, the first protrusion 551, and the first protrusiong 561 of a second holder 500, which are described later, to connect the first holder 400 and the second holder 500 so as to be slidable along the longitudinal direction (x-direction).

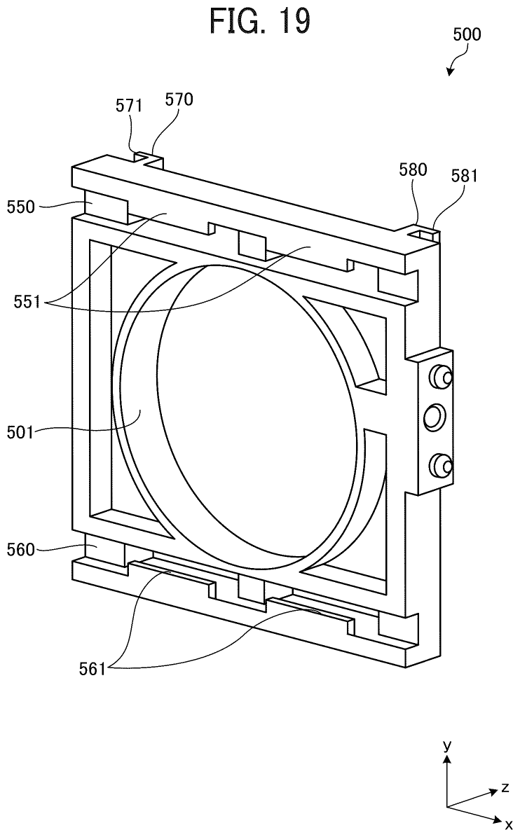

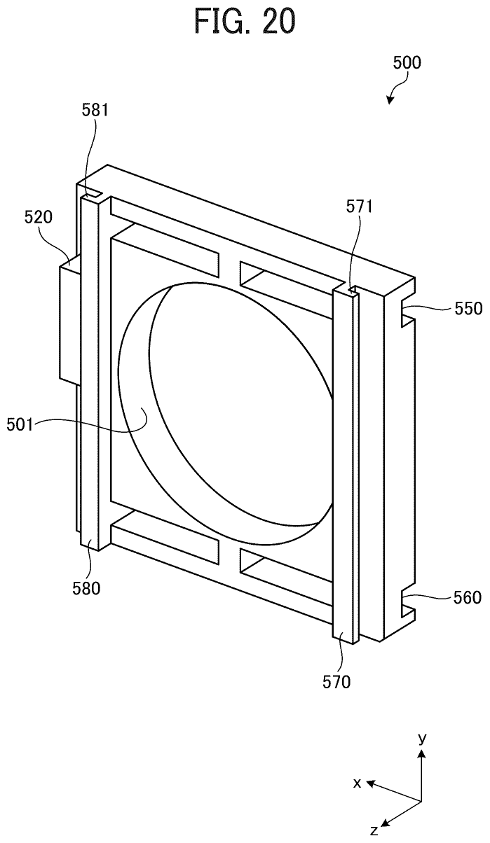

FIGS. 19 and 20 are diagrams of the appearance of the second holder 500. FIG. 19 is a perspective view as viewed from the front side, and FIG. 20 is a perspective view as viewed from the back side. The second holder 500 has an appearance of a substantially rectangular plate, and a hole 501 having a diameter similar to that of the hole 401 is installed in the central portion of the second holder 500.

The second holder 500 includes an attachment portion 520 to which the first biasing member 510 is attached on one of the side surfaces. The attachment portion 520 is installed so as to protrude from the outer peripheral surface (side surface) of the second holder 500. Since the root portion of the first biasing member 510 is fixed to the attachment portion 520, the root portion of the first biasing member 510 is separated from the side surfaces of the second holder 500 and the first holder 400. The first biasing member 510 having one end (in the vicinity of the root portion) fixed to the attachment portion 520 presses the side surface of the first holder 400 at the other end (in the vicinity of the tip portion).

The second holder 500 further includes a first groove 550, a first groove 560, a first protrusion 551, and a first protrusion 561 on the front side (FIG. 19). The first groove 550 and the first groove 560 are recessed from the front surface of the second holder 500, and is installed so that the longitudinal direction thereof is along the width direction (x-direction, first direction). The first protrusion 551 and the first protrusion 561 are portions protruded from the edge of the first groove 550 and the first groove 560, respectively, in the direction (i.e., y-direction) in which the width of the first groove 550 and the first groove 560 are reduced. The first groove 550, the first groove 560, the first protrusion 551, and the first protrusion 561 respectively cooperate with the first rail 450, the first rail 460, the first hook portion 451, and the first hook portion 461 to connect the first holder 400 and the second holder 500 so as to be slidable along the longitudinal direction (i.e., x-direction).

Movement in the z-direction is prevented by interference between the first hook portion 451 and the first protrusion 551 and the first hook portion 461 and the first protrusion 561. Since the first rail 450 does not come out of the first groove 550, and the first rail 460 does not come out of the first groove 560, a stable sliding movement can be obtained.

Further, the second holder 500 further includes a second rail 570, a second rail 580, a second hook portion 571, and a second hook portion 581 on the back side (FIG. 20). The second rail 570, and the second rail 580 protrudes from the back surface of the second holder 500, and are installed so that the longitudinal directions thereof are aligned with the height direction (y-direction). The second hook portion 571 and the second hook portion 581 are bent from the protrude direction (z-direction) of the second rail 570 and the second rail 580, respectively, and form an approximately L-shape in the transverse plane (xz-section) together with the second rail 570, and the second rail 580. The second rail 570, the second rail 580, the second hook portion 571, and the second hook portion 581 respectively cooperate with the second groove 370, the second groove 380, the second protrusion 371, and the second protrusion 381 of the holder base 300, which will be described later, to connect the second holder 500 and the holder base 300 so as to be slidable along the longitudinal direction (y-direction).

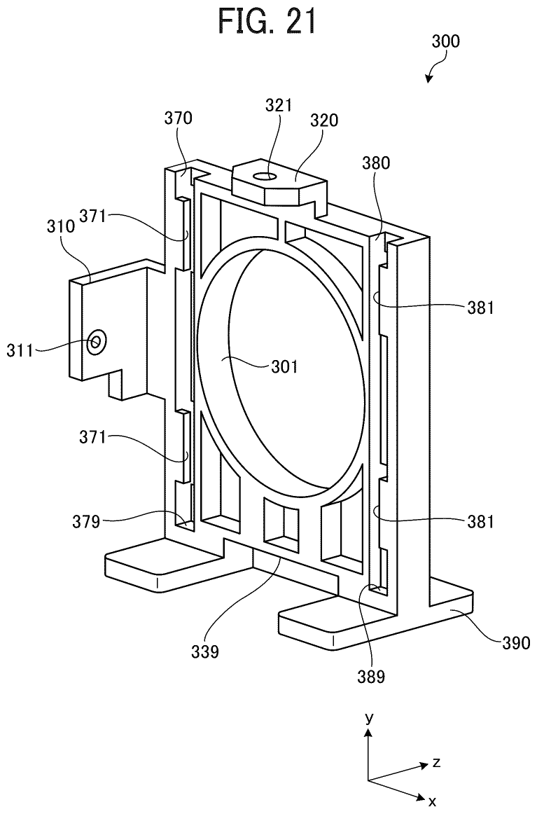

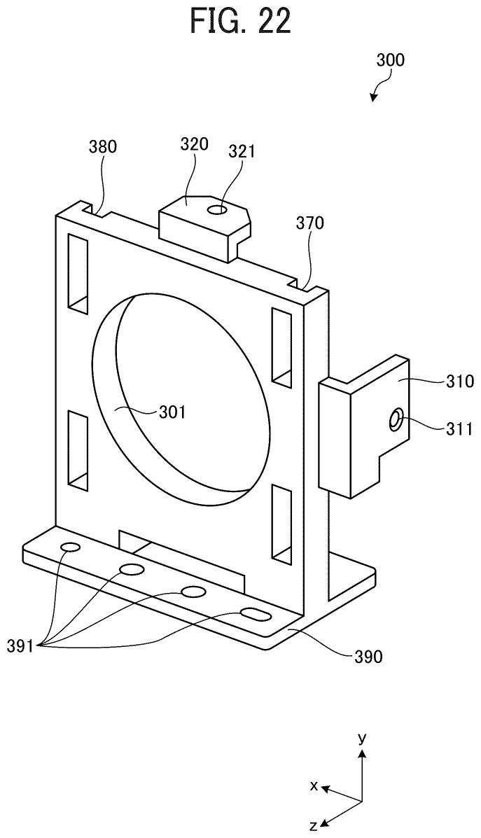

FIGS. 21 and 22 are diagrams of the appearance of the holder base 300. FIG. 21 is a perspective view as viewed from the front side, and FIG. 22 is a perspective view as viewed from the back side. The holder base 300 has, for example, an appearance of a rectangular plate, and a hole 301 having a diameter similar to a diameter of the hole 401 and a diameter of the hole 501 is installed in the central portion of the holder base 300.

The holder base 300 includes a leg portion 390 having a substantially U-shape in a plan view and can stand. The leg portion 390 has a screw hole 391 (FIG. 22) to fix the lens holder 600 to the casing of the light source device 1. The U-shape of the leg portion 390 has an opening, and the opening is on the front side.

The holder base 300 has an attachment portion 339 to which the second biasing member 330 is attached at the center portion of the lower surface of the substantially rectangular plate-shaped portion. The attachment portion 339 is disposed between the U-shaped opening of the leg portion 390. One end (in the vicinity of the root portion) of the second biasing member 330 is fixed to the attachment portion 339, and the other end (in the vicinity of the tip portion) of the second biasing member 102 presses the lower surface of the second holder 500.

The holder base 300 further includes a second groove 370, a second groove 380, a second protrusion 371, and a second protrusion 81 on the front side (FIG. 21). The second groove 370 and the second groove 380 are recessed from the front surface of the holder base 300, and are installed so that the longitudinal directions are aligned with the height direction (y-direction, second direction). The second protrusion 371 and the second protrusion 381 are portions protruded from the edge of the second groove 370 and the second groove 380, respectively, in a direction (x-direction) in which the width of the second groove 370 and the second groove 380 are reduced. The second groove 370, the second groove 380, the second protrusion 371 and the second protrusion 381 respectively cooperate with the second rail 570, the second rail 580, the second hook portion 571, and the second hook portion 581 to connect the second holder 500 and the holder base 300 so as to be slidable along the longitudinal direction (y-direction).

Further, movement in the z-direction is prevented by interference between the second hook portion 571 and the second protrusion 371 and between the second hook portion 581 and the second protrusion 381. Since the second rail 570 and the second rail 580 do not come out of the second grooves 370 and 380, a stable sliding movement can be obtained.

The lens holder 600 having such a configuration holds the condenser lens 12 so as to be adjustable in two axes (width direction and height direction in the present embodiment). According to the present embodiment, the positional adjustment of two directions (two axes) can be performed with respect to the condenser lens 12 (single condenser lens). As a result, the structure for positional adjustment, which is typically installed at multiple positions, can be integrated, so that the light source device 1 can be reduced in size.

Typically, in an adjustment process of the light source device, the casing member is opened, the adjustment is performed, and the casing member is closed. Such an additional adjustment process is inconvenient for the user. In addition, energization is performed while opening the casing member. However, in the light source device 1 according to the present embodiment, the casing holes through which the user can access the head portion 351 of the first adjustment screw 350 or the head portion 361 of the second adjustment screw 360 from outside the casing member. Thus, since the condenser lens 12 can be adjusted by two axes from the outside of the casing member the additional adjustment process can be omitted. Accordingly, the repetition of adjustment and energization can be performed while the case is closed. In such a way, the adjustment or the energization of the light source device is convenient for the user.

In some embodiments, the first rail 450 and the first groove 550 may be installed oppositely to each other. Specifically, the first holder 400 may include the first groove, and the second holder 500 may include the first rail. Similarly, the second rail 570 and the second groove 370 may be installed oppositely to each other. Specifically, the second holder 500 may include the second groove, and the holder base 300 may include the second rail.

In some embodiments, the first screw hold portion 310 may be installed in the second holder 500.

In some embodiments, in the light source device, the first condenser lens is between the light source and the wavelength converter to reduce the first light beam. The first adjuster includes: a first holder; a second holder; a holder base; a first adjustment member; and a second adjustment member, the first holder, the second holder, and the holder base are assembled in this order in the first direction, the first adjustment member is to adjust the position of the first condenser lens in one of the second direction and the third direction, and the second adjustment member is to adjust the position of the first condenser lens in another of the second direction and the third direction.

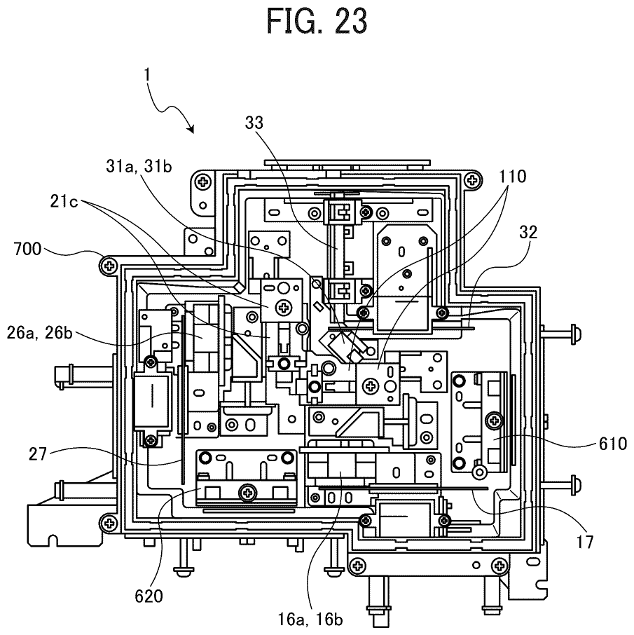

Further, the light source device 1 includes a casing member 700 (FIG. 23) to hold, which is directly or indirectly, various optical system members (e.g., a first condenser element, a first condenser lens, a condenser optical system, a wavelength conversion element, a wavelength converter, a second condenser element, or a second condenser lens) and a hold member to integrate.

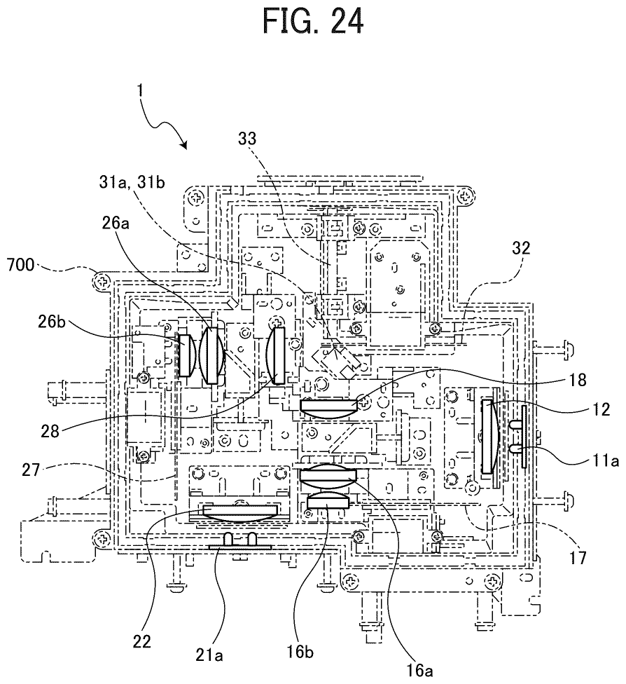

FIG. 23 is a diagram of the light source device 1 including the casing member 700 as an example, and FIG. 24 is a diagram of the arrangement of optical system components.

FIG. 23 is a view of the first light source module 10, and the second light source module 20 as viewed from a direction perpendicular to the arrangement direction (e.g., view from the top).

As illustrated in FIG. 23, in the light source device 1, the casing member 700 covers various optical system members and hold members in order to prevent the laser light and the fluorescent light beam emitted from the first light source module 10 and the second light source module 20 from going out and also to prevent dust from entering from the outside. In FIG. 23, the upper cover is removed from the casing member 700.

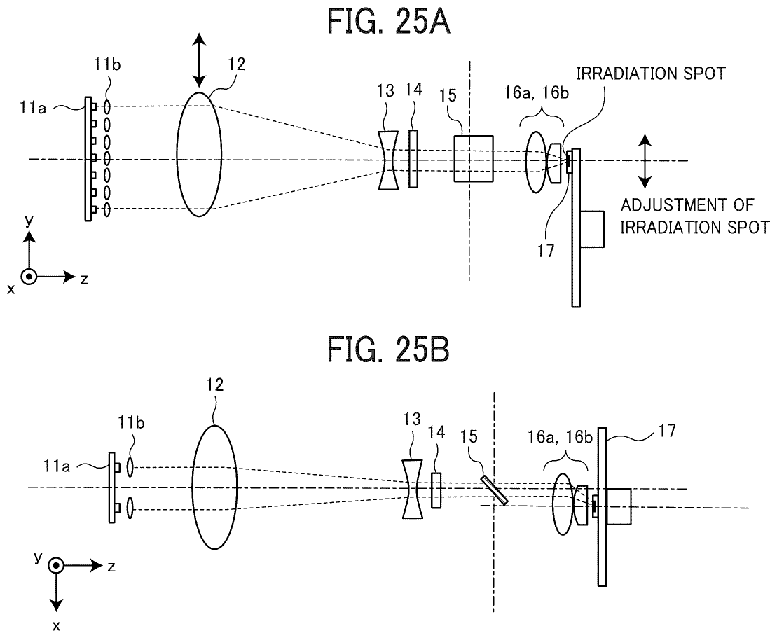

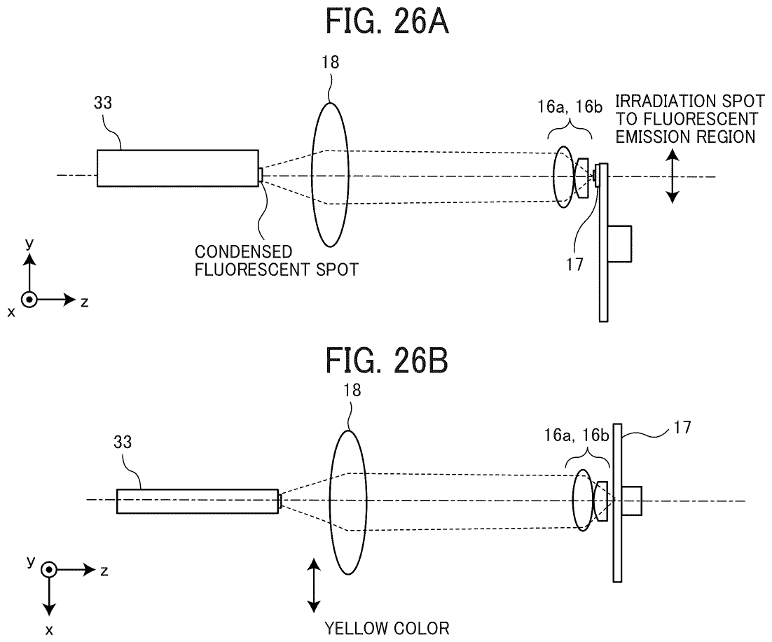

FIGS. 25A and 26B are diagrams of the optical path of the excitation light beam emitted from the light source to the phosphor wheel. In FIGS. 25A and 25B, an equivalent optical path is illustrated for the sake of convenience. The light beam condensed by the condenser lens 12 is reflected by the dichroic mirror 15 to form an irradiation spot on the phosphor wheel 17. In FIGS. 25A and 25B, the optical system equivalent to an optical system without dichroic mirror 15 is used in the drawings.

The light source 11a (e.g., multi-chip LD module) of the light source device 1 includes, for example, 2×7 LD chips arranged in two dimensions. In the light source 11a, the array of the collimator lenses 11b corresponding to, for example, a 2×7 LD chip is arranged in front of the light source 11a. In the light source 11a, the y-direction in which seven LD chips are arranged is a direction of the longitudinal side. In the light source 11a, two rows of LD chips are arranged in the x-direction orthogonal to the y-direction. Thus, in the light source 11a, the width of the light beam is increased because the number of LD chips arranged in the direction of the longitudinal side is increased.

In the light source device according to some embodiments, each of the light source of the first light source module and the light source the second light source module include multiple light sources arrayed to have a two dimensional rectangular shape having a longitudinal side and a lateral side, and the longitudinal side of the light source is along the longitudinal side of the light incident opening of the light homogenizer.

Preferably, the condenser lens 12 has a positive power. Preferably, the condenser lens 12 has a rotationally symmetry because of manufacturing process and mass production, and further has a circular aperture. Preferably, the condenser lens 12 captures the entire light beam emitted from the light source 11a as much as possible by adjusting the condenser lens 12 in the longitudinal direction of the light source 11a. As a result, the light capturing efficiency increases.

Since the light source 11a has two rows in the x-direction whose total width of the light beam is smaller, the condenser lens 12 may omit adjustment in x-direction if the entire light beam is captured in accordance with the width of the longitudinal side. However, when the opening of the condenser lens 12 is a shape other than the circular (e.g., oval shape), a different adjustment may be performed.

As described above, according to the present embodiment, by installing the adjustment member (first adjustment member 610 and second adjustment member 620) to adjust the condenser lens 12 and the condenser lens 22 in the y-direction, the light beam emitted from the light source 11a and the light beam emitted from the light source 21a (i.e., multichip LD modules) can efficiently be captured.

In the present embodiment, the light sources 11a and 21a (multichip LD modules) have a configuration of a two-dimensional array, for example, 2×7 LD chips, but the number of arrangement of the light sources 11a and 21a (multichip LD modules) is not limited to 2×7.

Further, according to the present embodiment, the irradiation spot can be formed on the phosphor by disposing the phosphor on the phosphor wheel 17 at a position optically conjugate with the position of the light source 11a by adjusting the condenser lens 12, the condenser lens 16a, and the condenser lens 16b. At this time, when the condenser lens 12 is shifted in the y-direction, the irradiation spot on the phosphor that is a conjugate image also moves in the y-direction in accordance with the shift amount of the condenser lens 12.

FIGS. 26A and 26B are diagrams of the optical path of the fluorescent light beam emitted from the phosphor wheel to the light tunnel. As illustrated in FIGS. 26A and 26B, in the light source device 1, the light source emits the excitation light beam to the phosphor on the phosphor wheel 17, and a secondary light source is formed at a position which the excitation light beam strikes on the phosphor. The phosphor converts the wavelength band of the excitation light beam into another wavelength band (fluorescent light). The secondary light source on the phosphor emits the fluorescent light according to the shape and the position.

The fluorescent light is again captured in by the condenser lenses 16a and 16b to condense the excitation light, and the fluorescent light condensed by the condenser lenses 16a and 16b is condensed by the condenser lens 18 and captured into the light tunnel 33.

In the light tunnel 33, the incident light beam is reflected multiple times on the inner surfaces of the light tunnel 33 while propagating. As a result, the incident light beam is sufficiently homogenized and exits from the light exit opening of the light tunnel 33 as a light beam having a homogenized (uniform) light intensity distribution.

Preferably, the aspect ratio of the light exit opening of the light tunnel 33 corresponds to the aspect ratio of the image generation element IM. The light beam can be most efficiently used as the illumination light. Herein, the aspect ratio is a ratio of the longitudinal side (longer side) and the lateral side (shorter side) of the light exit opening or the image generation element IM.

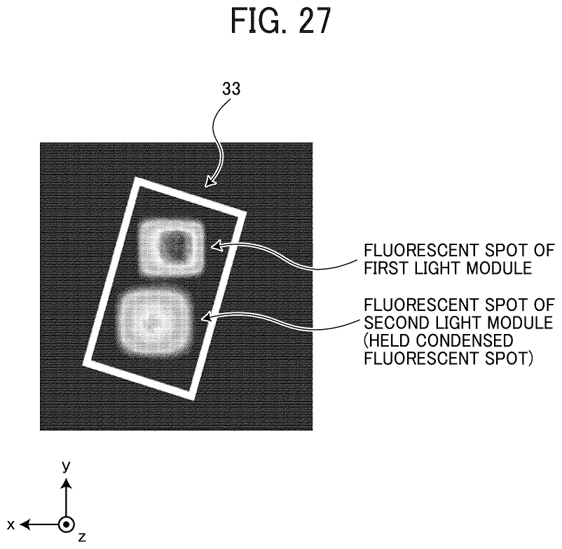

Since the image generation element IM typically has a rectangular shape having a longitudinal side (longer side) and a lateral side (shorter side), the light tunnel preferably has a light incident opening having a rectangular shape corresponding to the rectangular shape of the image generation element IM. Preferably, in the direction of the longitudinal side of the light incident opening of the light tunnel, two condensed spots formed by the first light source module 10 and the second light source module 20 are arranged or overlapped to capture the light beam efficiently. In the present embodiment, as described in FIG. 27, two condensed spots are adjacently arranged along the direction of the longitudinal side of the light incident opening.

FIGS. 26A and 26B are diagrams of a fluorescent light path of the first light source module 10. FIG. 26A is a diagram of a state in which the condensed spot of the fluorescent light is incident on the lower side (side of the −y direction) which is displaced from the center of the light tunnel 33 that is the longitudinal side in the y-direction. The condensed spot of the fluorescent light beam emitted from the second light source module 20 is incident on the upper side (side of the +y-direction) which is displaced from the center of the light tunnel 33. In the light source device 1, the first light source module 10 and the second light source module 20 are arranged so that the condensed spot of the fluorescent light beam is formed at the position as illustrated in FIGS. 26A and 26B, and the light source device 1 captures the fluorescent light beams emitted from the first light source module 10 and the second light source module 20. The number of the light source module is not limited two. Three or more light source modules may be used in the light source device 1.

The light source device 1 according to the present embodiment has a higher robustness because the light beams emitted from the first light source module 10 and the second light source module 20 are captured by the light tunnel 33 along the longitudinal side. The casing member 700 holds the light tunnel 33 so that the position of the condensed spot formed by the first light source module 10 and the position of the condensed spot formed by the second light source module 20 are along the direction of the longitudinal side of light incident opening of the light tunnel 33 As a result, the amount of the light beam is effectively increased when the light beam emitted from the first light source module 10 and the light beam emitted from the second light source module 20 are combined for the illumination light.

In some embodiments, the position of the first light condensed spot and the position of the second light condensed spot are arrayed along the longitudinal side of the light incident opening of the light homogenizer.

In some embodiments, the first condenser lens of the first light source module and the second condenser lens of the second light source module are adjusted in a direction parallel to the longitudinal side of the light incident opening of the light homogenizer. When the condenser lens 18 and the condenser lens 28 are adjusted in the lateral side direction of the light entrance of the light tunnel 33 or in an arrangement direction of the condensed spot of the fluorescent light beam in combining the first light source module 10 and the second light source module 20, the first adjustment portion 110 and the second adjustment portion 210 may be omitted. A configuration of the light source device 1 without the first adjustment portion 110 and the second adjustment portion 210 can be designed. However, the first adjustment portion 110 and the second adjustment portion 210 in the direction of the substantially lateral side of the light incident opening of the light tunnel 33 (x-direction in FIG. 26) is very effective for increasing the light utilization efficiency because the amount of captured light may be lost and the light may not be used as illumination light if the condensed spots of the fluorescent light beams from the condenser lenses 18 and 28 are shifted by, for example, assembling.

In some embodiments, the second condenser lens of the first light source module and the second condenser lens of the second light source module are adjusted in a direction parallel to the lateral side of the light incident opening of the light homogenizer.

FIG. 27 is a diagram of an example of the condensed spot of the fluorescent light beam (fluorescent light condensed spot) at an incident position of the light tunnel 33. As illustrated in FIG. 27, the longitudinal side (longer side) of the light incident opening of the light tunnel 33 is arranged in the y-direction (substantially vertical direction), and the lateral side (shorter side) of the light incident opening of the light tunnel 33 is arranged in the x-direction (substantially horizontal direction). The light tunnel 33 slightly rotates around the z-axis as the rotation axis. When the rectangle shape of the light tunnel 33 is divided into vector components in the x-direction or the y-direction, the longer component is the direction of the longitudinal side and the shorter component is the direction of the lateral side. Preferably, the upper limit of the rotation of the light tunnel 33 is less than 45 degrees, and the effect of the configuration of the present embodiment can be obtained.

As described above, according to the present embodiment, since the fluorescent light condensed spot of the first light source module 10 and the fluorescent light condensed spot of the second light source module 20 are mainly arranged along the longitudinal side, a larger amount of light can be captured into the light tunnel 33 by adjusting the direction of the lateral side (x-direction in FIG. 27) of the condenser lens 18 and the condenser lens 28. The casing member 700 holds the light tunnel 33 so that the light incident opening of the light tunnel 33 is disposed on a position in the vicinity of the position of the irradiation spot formed on the phosphor wheel 17 by the first light source module 10 and the position of the irradiation spot formed on the phosphor wheel 27 by the second light source module 20.

Examples of the display apparatus 100 including the light source device 1 described above include a projector to project a predetermined image. Herein, the hardware configuration of the display apparatus 100 as a projector will be described.

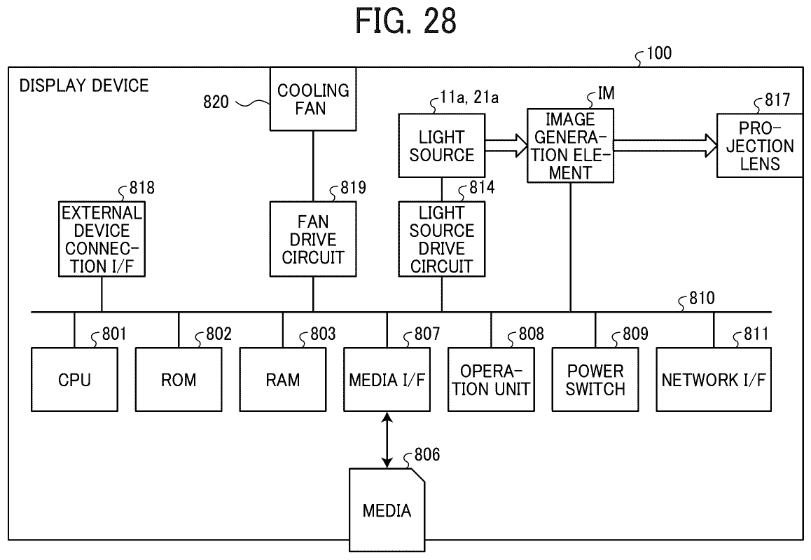

FIG. 28 is a block diagram of the hardware configuration of the display apparatus 100. As illustrated in FIG. 28, the display apparatus 100 includes a central processing unit (CPU) 801, a read only memory (ROM) 802, a random access memory (RAM) 803, a media interface (I/F) 807, an operation unit 808, a power switch 809, a bus line 810, a network interface (I/F) 811, a light source drive circuit 814, light sources 11a and 21a, an image generation element IM as a spatial light modulation device, a projection lens 817, an external device connection interface (I/F) 818, a fan drive circuit 819, and a cooling fan 820.

The CPU 801 controls the entire operation of the display apparatus 100. The ROM 802 stores a program used to drive the CPU 801. The RAM 803 is used as a working area of the CPU 801.

The media I/F 807 controls the media 806 such as a flash memory to read or write (store).

The operation unit 808 is provided with various keys, buttons, or LEDs, and is used to perform various operations other than ON and OFF (ON/OFF) of the power supply of the display apparatus 100 by the user. For example, the operation unit 808 receives instruction operations such as an adjustment of the size of the projection image, an adjustment of the color tone, a focus adjustment, and a keystone adjustment, and outputs the received operation to the CPU 801.

The power switch 809 is a switch to switch ON and OFF the power of the display apparatus 100.

The bus line 810 is an address bus or a data bus for electrically connecting each component such as the CPU 801 in FIG. 28.

The network OF 811 is an interface to perform data communication using a communication network such as the Internet.

The light source drive circuit 814 controls the light sources 11a and 21a to turn on and off under the control of the CPU 801.

When the light sources 11a and 21a are turned on under the control of the light source drive circuit 814, the light sources 11a and 21a emit the light in the light source device 1. The light beam output from the light source device enters the illumination optical system and becomes the illumination light beam. In the illumination optical system, the image generation element IM is irradiated with the illumination light.

The image generation element IM using a spatial light modulation method modulates the illumination light based on an image data given via the external device connection IN 818 and generates an image light. The image light is projected onto a screen by the projection lens 817. As the image generation element IM, for example, a liquid crystal panel or a digital micromirror device (DMD) is used. The light source drive circuit 814, the light sources 11a and 21a, the image generation element IM, and the projection lens 817 work as a projection unit (projection means) to project a projection image onto a projection surface based on image data.

A personal computer (PC) is directly connected to the external device connection OF 818 to acquire control signals and image data with the PC.

The fan drive circuit 819 is connected to the CPU 801 and the cooling fan 820, and drives or stops the cooling fan 820 based on a control signal from the CPU 801.

The cooling fan 820 exhausts the air inside the display apparatus 100 to cool the inside of the display apparatus 100 by rotating the fan.

When the electric power is supplied, the CPU 801 is activated according to a control program stored in the ROM 802 in advance, and provides a control signal to the light source drive circuit 814 to turn on the light sources 11a and 21a and also provides a control signal to the fan drive circuit 819 to rotate the cooling fan 820 at a predetermined speed. In the display apparatus 100, when the electric power is supplied from the power supply circuit, the image generation element IM is on a standby state to display an image, and further, electric power supplied from the power supply circuit is provided to other various components.

In the display apparatus 100, when the power switch 809 is turned off, a power OFF signal is sent to the CPU 801 from the power switch 809. When the CPU 801 detects the power OFF signal, the CPU 801 provides a control signal to the light source drive circuit 814 to turn off the light sources 11a and 21a. After passing a predetermined time, the CPU 801 provides a control signal to the fan drive circuit 819 to stop the cooling fan 820, finishes the CPU's control processing, and provides an instruction to the power supply circuit to stop the power supply.

In the present embodiment described above, a preferable example is described, but the present embodiment is not limited thereto.

In particular, the specific shapes and numerical values of the respective components exemplified in the embodiments are merely examples for implementing the disclosure. The technical scope of the disclosure should not be limitedly interpreted thereby.

As described above, the present invention is not limited to the contents described in each of the above-described embodiments, and can be appropriately modified without departing from the gist thereof.

Aspects of the present invention is as follows, for example.

In a first aspect, a light source device includes: a light source to emit a laser light beam; a wavelength converter to convert a wavelength band of the laser light beam; a light homogenizer to homogenize the light beam having the wavelength band converted by the light converter and to emit the light beam in a predetermined direction; a condenser lens to condense the light beam and to send the light beam to the light homogenizer; a holder to hold the condense lens; a housing to house the lens holder and to fix the position of the condenser lens with respect to the light homogenizer in a first direction perpendicular to the optical axis of the condenser lens; an adjuster to adjust the position of the condenser lens in a direction perpendicular to the optical axis and the first direction. The lens holder has a first side, a second side, and a third side. The second side and the third side are opposite to each other. The second side and the third side extend from the both ends of the first side so that the second side and the third side are perpendicular to the first side. The lens holder has a frame surrounding the condenser lens. The lens holder also has an inclinations portion that connects the first side and the second side. The adjuster is installed on a frame opposite to the first side so to move in an extending direction and has an adjustment screw and an elastic member. The adjustment screw extends to the lens holder from the frame and the tip of the adjustment screw touches the inclination portion. The elastic member extends to the lens holder from the frame and touches the third end.

In a second aspect, in the light source device according to the first aspect, the inclination portion is inclined with respect to the first side by 45 degrees or less.

In a third aspect, in the light source device according to the first aspect, the inclination portion is located at a position displaced from the center of the condenser lens held by the lens holder along the first direction to the first side.

In a fourth aspect, in the light source device according to the first aspect, the adjuster extend to the lens holder from the frame and further includes the press member to touch the first side.

In a fifth aspect, in the light source device according to the first aspect, the lens holder has a fourth side, a leg portion, and a guide hole. The fourth side is opposite to the first side and perpendicular to the second side and the third side. The leg portion touches the base of the housing. The guide hole extends to the first direction that is the longitudinal direction. The base has a guide pin to be insert the guide hole.

In a sixth aspect, in the light source device according to the fifth aspect, the leg portion is fixed to the housing by the fixing member.

In a seventh aspect, in the light source device according to the sixth aspect, the fixing member is a fixing screw to penetrate through the leg portion and to be fixed on the base or adhesive to put between the contact surface of the leg portion and the base.

In an eighth aspect, in the light source device according to the first aspect, the first side and the third side are connected by another inclination portion that inclined with respect to the first side and the third side.

In a ninth aspect, in the light source device according to the first aspect includes: the laser light source includes a first laser light source to emit the first light beam and a second laser light source to emit the second light beam, the wavelength converter includes a first wavelength converter to convert the wavelength band of the first light beam and a second wavelength converter to convert the wavelength band of the second light beam, the condenser lens includes a first condenser lens to condense the first light beam whose wavelength band is converted by the first wavelength converter and to send the first light beam to the light homogenizer and a second condenser lens to condense the second light beam whose wavelength band is converted by the second wavelength converter and to send the second light beam to the light homogenizer, the lens holder includes a first lens holder to hold the first condenser lens and fixed the position of the first condenser lens with respect to the light homogenizer and housed in the housing and a second lens holder to hold the second condenser lens and fixed the position of the first condenser lens with respect to the light homogenizer and housed in the housing, and the first condenser lens held by the first holder and the second condenser lens held by the second holder are arranged in the housing so that the optical axis of the first condenser lens and the optical axis of the second condenser lens are perpendicular to each other.

In a tenth aspect, in the light source device according to the ninth aspect, the first lens holder and the second lens holder are fixed to the base of the housing, and a portion of the base to which the first lens holder is fixed is thicker than a portion of the base to which the second lens holder is fixed.

In an eleventh aspect, the light source device according to the ninth aspect, the housing houses the first lens holder and the second lens holder so that the third end of the first lens holder and the third end of the second lens holder are adjacent to each other. The adjuster includes the first adjuster to adjust the position of the first condenser lens in the second direction perpendicular to the optical axis of the first lens and the first direction, and the second adjuster to adjust the position of the second condenser lens in the third direction perpendicular to the optical axis of the second condenser lens and the first direction. The first adjuster includes the first adjustment screw the first elastic member. The first adjustment screw is installed at the frame arranged at a position opposite to the first side of the first lens holder and extends to the first lens holder from the frame, and the tip of the adjustment screw comes into contact with the inclination portion of the first lens holder. The first elastic member extends to the first lens holder from the frame and comes into contact with the third side of the first lens holder. The second adjuster includes the second adjustment screw the second elastic member. The second adjustment screw is installed at the frame arranged at a position opposite to the first side of the second lens holder and extends to the second lens holder from the frame, and the tip of the adjustment screw comes into contact with the inclination portion of the second lens holder. The second elastic member extends to the second lens holder from the frame and comes into contact with the third side of the first lens holder.

In a twelfth aspect, in the light source device according to the eleventh aspect, the first lens holder and the second lens holder have the same shape. The first lens holder and the second lens holder have the inclination portion connect the first end and the third end.

In a thirteenth aspect, a light homogenization device includes a light source to emit laser light beam having a first wavelength band; a wavelength converter to converter the first wavelength band of the laser light beam emitted from the light source int a light beam having a second wavelength band; a light homogenizer to homogenizer the light beam having the second wavelength band and emit the beam in a predetermined direction; a condenser lens to condense the light beam and send the light homogenizer; a lens holder to hold the condenser lens; a housing to house the lens holder and to fix the position of the condenser lens with respect to the light homogenizer in the first direction perpendicular to the optical axis of the condenser lens and the first direction, and an adjuster to adjust the position of the condenser lens in the direction perpendicular to the optical axis and the first direction. The lens holder has a first side, a second side, and a third side. The second side and the third side are opposite to each other. The second side and the third side extend from the both ends of the first side so the second side and the third side are perpendicular to the first side. The lens holder has a frame surrounding the condenser lens. The lens holder also has an inclinations portion that connects the first side and the second side. The adjuster is installed on a frame opposite to the first side so to move in an extending direction and has an adjustment screw and an elastic member. The adjustment screw extends to the lens holder from the frame and the tip of the adjustment screw comes into contact with the inclination portion. The elastic member extends to the lens holder from the frame and comes into contact with the third end.

In a fourteenth aspect, a display apparatus includes the light source device according to any one of the first aspect to the twelfth aspect; an image generation element to generate an image based on a graphic signal received; an illumination optical system to illuminate the image generation element with the light beam from the light homogenizer; and a projection optical system to project the image to outside.

Further, an aspect of the present invention is as follows, for example.

In a first aspect, a light source device includes: a light source to emit a light beam; a wavelength converter to emit a fluorescent light beam by light excitation; a light beam reduction element to reduce the light beam and disposed between the light source and the wavelength converter; a first holder to hold the light beam reduction element by surrounding the peripheral of the light beam reduction element; a second holder having a shape of a frame through which the light beam passing through the light beam reduction element hold by the first lens holder; a holder base installed to the casing of the device in which the light source is used; the first adjustment member to adjust the position of the light beam reduction element in a first direction perpendicular to a direction in which the first holder and the holder base or the second lens holder are assembled; a second adjustment member to adjust the position of the light beam reduction element in a second direction perpendicular to the first direction and a direction the second holder and the holder base are assembled; and a hold member to hold the adjustment by the first adjuster and the adjustment by the second adjuster by biasing the first holder, the second holder, and the holder base so to approach to each other in the direction the first holder, the second holder, and the holder base are assembled.

In a second aspect, in the light source device according to the first aspect, the first adjuster includes a first adjustment screw whose axis is directed to the first direction and whose tip comes to contact with the outer surface of the first holder and a first biasing member to press the outer surface of the first holder from the opposite side that the first adjustment screw touches, and the second adjuster includes a second adjustment screw whose axis is directed to the second direction and whose tip touches the outer surface of the second lens holder and a second biasing member to press the outer surface of the second holder from the opposite side that the second adjustment screw touches.

In a third aspect, the light source device according to the first aspect further includes: a first rail; a first hook portion; a first groove; a first convex portion; a second hook portion; a second groove; and a second convex portion. The first rail extends in the first direction and is protruded from one side of the first holder and the second holder. The first hook portion is bent from the tip of the first rail. The first groove is a longer groove extending in the first direction and installed on the other side of the first holder and the second holder. The first groove enables the first rail and the first hook portion to move in the first direction while holding the first rail and the first hook portion. The first convex portion is a portion protruded from the end of the first groove so that the width of the first groove becomes narrower. The first convex portion also prevents the first hook portion from getting away from the first groove. The second hook portion is on one side of the second holder and the holder base and bent from the tip of the second rail extending in the second direction The second groove is a longer groove extending in the second direction and on the other side of the second holder and the holder base. The second groove enables to the second rail and the second hook portion to move in the second direction while holding. The second convex portion is a portion protruded from the end of the second groove so that the width of the second groove becomes narrower. The second convex portion also prevents the second hook portion from getting away from the second groove.

In a fourth aspect, in the light source device according to the first aspect, one end portion of the hold member is fixed to the first holder and the other end portion of the hold member is a flat spring to press the second holder from the side opposite to the one end portion.

In a fifth aspect, in the light source device according to the first aspect, the hold member is installed on at least multiple positions on the top portion or the both side portions of the first lens holder.

In a sixth aspect, in the light source device according to the second aspect, the casing of the light source device has a hole to expose a head portion of the first adjustment screw and a head portion of the second adjustment screw to access from outside of the casing.

In a seventh aspect, the projector apparatus includes the light source device according to any one of the first aspect to the sixth aspect; a light homogenizer to homogenizer the light beam emitted from the light source device; an image generation element to generate an image by modulation the light from the light homogenizer; and a projection optical system to magnify and project the image onto the screen.

Further, an aspect of the present invention is as follows, for example.

In a first aspect, a light source module includes: a light source to emit a light beam having a first wavelength band in a first direction; a first condenser lens to condense the light beam emitted from the light source in the first direction; a condenser optical system to condense the light beam from the first condenser lens in a second direction orthogonal to the first direction to form an irradiation spot; a wavelength converter to convert the first wavelength band of the light beam condensed by the condenser optical system into a light beam having a second wavelength band; a second condenser lens to condense the light beam having the second wavelength band converted by the wavelength converter at a predetermined position, a first adjuster to adjust a position of the first condenser lens in at least one of the second direction or a third direction orthogonal to each of the first direction and the second direction; and a second adjuster to adjust a position of the second condenser lens in at least one of the first direction or the third direction.

In a second aspect, a light source device includes: the light source module according to the first aspect; and a light homogenizer having a light incident opening in one end of the light homogenizer in a longitudinal direction of the light homogenizer, the light incident opening having a rectangle shape having a longitudinal side and a lateral side. The light source module according to the first aspect includes: a first light source module to emit a first light beam to the light homogenizer in a fourth direction to form a first light condensed spot at a first position in the light incident opening; a second light source module to emit a second light beam to the light homogenizer in a fifth direction to form a second light condensed spot at a second position adjacent to the first light condensed spot in the light incident opening; and a reflector to bent one of the first light beam and the second light beam to align an emission direction of the first light beam and the second light beam to one of the fourth direction or the fifth direction. The fourth direction is one of the first direction and the second direction, and the fifth direction is another of the first direction and the second direction.

In a third aspect, in the light source device according to the second aspect, the position of the first light condensed spot and the position of the second light condensed spot are arrayed along the longitudinal side of the light incident opening of the light homogenizer.

In a fourth aspect, in the light source device according to the second aspect or the third aspect, the first light source module includes at least one of the first adjuster or the second adjuster, and the second light source module includes at least one of the first adjuster or the second adjuster.

In a fifth aspect, in the light source device according to any one of the first aspect to the third aspect, the second condenser lens of the first light source module and the second condenser lens of the second light source module are adjusted in a direction parallel to the lateral side of the light incident opening of the light homogenizer.

In a sixth aspect, in the light source device according to any one of the second aspect to the fifth aspect, the first condenser lens of the first light source module and the second condenser lens of the second light source module are adjusted in a direction parallel to the longitudinal side of the light incident opening of the light homogenizer.

In a seventh aspect, in the light source device according to any one of the second aspect to the sixth aspect, each of the light source of the first light source module and the light source the second light source module include multiple light sources arrayed to have a two dimensional rectangular shape having a longitudinal side and a lateral side, and the longitudinal side of the light source is along the longitudinal side of the light incident opening of the light homogenizer.

In an eighth aspect, in the light source device according to any one of the second aspect to the seventh aspect, the first condenser lens is between the light source and the wavelength converter to reduce the first light beam. The first adjuster includes: a first holder; a second holder; a holder base; a first adjustment member; and a second adjustment member, the first holder, the second holder, and the holder base are assembled in this order in the first direction, the first adjustment member is to adjust the position of the first condenser lens in one of the second direction and the third direction, and the second adjustment member is to adjust the position of the first condenser lens in another of the second direction and the third direction.

In a ninth aspect, the light source device according to any one of the second aspect to the eighth aspect, the second adjuster is to adjust the position of the second condenser lens in the third direction.

In a tenth aspect, the light source device according to any one of the second aspect to the nineth aspect, further includes an L-shaped base including: a first portion; and a second portion adjacent to and orthogonal to the first portion. The second adjuster of the first light source module is installed on the first portion, and the second adjuster of the second light source module is installed on the second portion.

In an eleventh aspect, in the light source device according to the tenth aspect, the first portion has a first height; and the second portion has a second height different from the first height.

In a twelfth aspect, a projection apparatus includes: a light source device according to any one of the second aspect to the eleventh aspect; an image generation element to generate an image; an illumination optical system to guide a light beam emitted from the light source device to the image generation element; and a projection lens configured to project the image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A light source module comprising:
a light source configured to emit a light beam having a first wavelength band in a first direction;
a first condenser lens configured to condense the light beam emitted from the light source in the first direction;
a condenser optical system configured to condense the light beam from the first condenser lens in a second direction orthogonal to the first direction to form an irradiation spot;
a wavelength converter configured to convert the first wavelength band of the light beam condensed by the condenser optical system into a light beam having a second wavelength band;
a second condenser lens configured to condense the light beam having the second wavelength band converted by the wavelength converter at a predetermined position,
a first adjuster configured to adjust a position of the first condenser lens in at least one of the second direction or a third direction orthogonal to each of the first direction and the second direction; and
a second adjuster configured to adjust a position of the second condenser lens in at least one of the first direction or the third direction.

2. A light source device comprising;
the light source module according to claim 1; and
a light homogenizer having a light incident opening in one end of the light homogenizer in a longitudinal direction of the light homogenizer, the light incident opening having a rectangle shape having a longitudinal side and a lateral side,
wherein the light source module includes:
a first light source module configured to emit a first light beam to the light homogenizer in a fourth direction to form a first light condensed spot at a first position in the light incident opening;
a second light source module configured to emit a second light beam to the light homogenizer in a fifth direction to form a second light condensed spot at a second position adjacent to the first light condensed spot in the light incident opening; and
a reflector configured to bent one of the first light beam and the second light beam to align an emission direction of the first light beam and the second light beam to one of the fourth direction or the fifth direction,
the fourth direction is one of the first direction and the second direction, and
the fifth direction is another of the first direction and the second direction.

3. The light source device according to claim 2,
wherein the position of the first light condensed spot and the position of the second light condensed spot are arrayed along the longitudinal side of the light incident opening of the light homogenizer.

4. The light source device according to claim 2,
wherein the first light source module includes at least one of the first adjuster or the second adjuster, and
the second light source module includes at least one of the first adjuster or the second adjuster.

5. The light source device according to claim 2,
wherein the second condenser lens of the first light source module and the second condenser lens of the second light source module are adjusted in a direction parallel to the lateral side of the light incident opening of the light homogenizer.

6. The light source device according to claim 2,
wherein the first condenser lens of the first light source module and the second condenser lens of the second light source module are adjusted in a direction parallel to the longitudinal side of the light incident opening of the light homogenizer.

7. The light source device according to claim 2,
wherein each of the light source of the first light source module and the light source the second light source module includes multiple light sources arrayed to have a two dimensional rectangular shape having a longitudinal side and a lateral side, and
the longitudinal side of the light source is along the longitudinal side of the light incident opening of the light homogenizer.

8. The light source device according to claim 2,
wherein the first condenser lens is between the light source and the wavelength converter to reduce the first light beam,
the first adjuster includes:
a first holder;
a second holder;
a holder base;
a first adjustment member; and
a second adjustment member,
the first holder, the second holder, and the holder base are assembled in this order in the first direction,
the first adjustment member is configured to adjust the position of the first condenser lens in one of the second direction and the third direction, and
the second adjustment member is configured to adjust the position of the first condenser lens in another of the second direction and the third direction.

9. The light source device according to claim 2,
wherein the second adjuster is configured to adjust the position of the second condenser lens in the third direction.

10. The light source device according to claim 9, further comprising an L-shaped base including:
a first portion; and
a second portion adjacent to and orthogonal to the first portion,
wherein the second adjuster of the first light source module is installed on the first portion, and
the second adjuster of the second light source module is installed on the second portion.

11. The light source device according to claim 10,
wherein the first portion has a first height; and
the second portion has a second height different from the first height.

12. A projection apparatus comprising:
a light source device according to claim 2;
an image generation element configured to generate an image;
an illumination optical system configured to guide a light beam emitted from the light source device to the image generation element; and
a projection lens configured to project the image.
